(19) United States
(12) Patent Application Publication
(10) Pub. No.: US 2026/0287319 A1
(43) Pub. Date: Sep. 24, 2026

(54) VANE ANGLE MEASUREMENT DEVICE AND VANE ANGLE MEASUREMENT METHOD USING SAME

(71) Applicant: MITSUBISHI HEAVY INDUSTRIES, LTD., Tokyo (JP)

(72) Inventor: Yasunori NISHIOKA, Tokyo (JP)

(21) Appl. No.: 19/474,011

(22) PCT Filed: May 2, 2024
(86) PCT No.: PCT/JP2024/016904

§ 371 Date: Oct. 9, 2025

(30) Foreign Application Priority Data
May 15, 2023 (JP) 2023-080111

(51) Int. Cl. G01B 5/24

(52) U.S. Cl. CPC G01B 5/24

(57) ABSTRACT

A vane angle measurement device includes a goniometer and a mount that supports the goniometer and can contact a second member of an axial flow fluid machine. The goniometer has a measurement arm that can contact an arm contact surface of a first member in the axial flow fluid machine, and a goniometer body that supports the measurement arm in a manner allowing rotation about a measurement center axis and is capable of measuring the rotation angle of the measurement arm. The mount has a base plate attached to the goniometer body, and first and second legs extending from the base plate in the direction of the measurement central axis. The first leg has a device reference surface that can contact a first leg contact surface of the second member, and an arm height maintaining surface capable of contacting a second leg contact surface of the second member.

### TECHNICAL FIELD

The present invention relates to a vane angle measurement device capable of measuring a rotation angle of a variable stator vane, and a vane angle measurement method using the same.

Priority is claimed on Japanese Patent Application No. 2023-080111 filed on May 15, 2023, the content of which is incorporated herein by reference.

### BACKGROUND ART

A gas turbine includes a compressor capable of compressing air, a combustor capable of combusting fuel in the air compressed by the compressor to generate a high-temperature and high-pressure combustion gas, and a turbine capable of being driven by the combustion gas from the combustor.

A compressor is a type of axial flow rotary machine, and includes a rotor that is rotatable about a rotor axis, a casing that covers an outer periphery of the rotor, a plurality of stator vane rows, and a vane angle changing mechanism. The rotor includes a plurality of rotor blade rows that are aligned in a rotor axis direction in which the rotor axis extends. Each of the plurality of rotor blade rows includes a plurality of rotor blades arranged in a circumferential direction with respect to the rotor axis. A plurality of stator vane rows are also arranged in the rotor axis direction. One or more stator vane rows on a rotor axis upstream side among the plurality of stator vane rows form a variable stator vane row. Each of the one or more variable stator vane rows includes a plurality of variable stator vanes arranged in the circumferential direction with respect to the rotor axis. Each of the plurality of variable stator vanes is rotatable around a vane rotational axis extending in a radial direction with respect to the rotor axis. The vane angle changing mechanism is a mechanism that rotates each of a plurality of variable stator vanes constituting one variable stator vane row around a respective vane rotational axis.

In an axial flow fluid machine, a maximum rotation angle and a minimum rotation angle of the variable stator vane may be inspected at the time of assembly, inspection, or the like. Therefore, the following PTL 1 discloses a measurement device for measuring an actual rotation angle of a variable stator vane when the variable stator vane is at a maximum rotation angle and a minimum rotation angle.

The vane angle changing mechanism applied to this measurement device has an outer rotary shaft, a first link piece, a second link piece, and a rotating ring, The outer rotary shaft is coupled to an end of the variable stator vane on a radially outer side with respect to the rotor axis, and has a cylindrical shape about the vane rotational axis. The first link piece is fixed to the outer rotary shaft and extends in the radial direction with respect to the vane rotational axis. The rotating ring is disposed on the radially outer side of the casing of the axial flow rotary machine with respect to the rotor axis, and has an annular shape about the rotor axis. The rotating ring is rotatable about the rotor axis. The second link piece is pin-joined to each of the first link piece and the rotating ring. In the vane angle changing mechanism, the rotating ring is rotated around the rotor axis, and the first link piece and the outer rotary shaft are integrally rotated about the vane rotational axis. As a result, the variable stator vane rotates about the vane rotational axis.

In the technique of PTL 1, a measurement device for measuring a maximum rotation angle and a measurement device for measuring a minimum rotation angle are required, the measurement device for measuring the maximum rotation angle being for measuring an actual rotation angle of the variable stator vane when the variable stator vane is at the maximum rotation angle, and the measurement device for measuring the minimum rotation angle being for measuring the actual rotation angle of the variable stator vane when the variable stator vane is at the minimum rotation angle. Each of the measurement devices has a stand (guide portion) and a contact piece (facing portion). The stand includes a substrate and a plurality of legs. The plurality of legs extend in a direction perpendicular to the substrate. The contact piece (facing portion) has an abutment surface capable of coming into contact with an end surface of the rotating ring that is perpendicular to the rotor axis. The contact piece is fixed to the substrate of the stand. However, the angle of the abutment surface of the contact piece with respect to the substrate of the stand is different between the measurement device for measuring the maximum rotation angle and the measurement device for measuring the minimum rotation angle.

When measuring the actual rotation angle of the variable stator vane at the maximum rotation angle, the measurement device for measuring the maximum rotation angle is used. At this time, after the variable stator vane is set to the maximum rotation angle, the plurality of legs of the stand are brought into contact with the first link piece such that the stand is rotatable integrally with the outer rotary shaft and the first link piece about the vane rotational axis. Further, the abutment surface of the contact piece is brought into contact with the end surface of the rotating ring. It is assumed that the current rotation angle of the variable stator vane is the target maximum rotation angle when the entire abutment surface of the contact piece is in contact with the end surface of the rotating ring. On the other hand, in a case where only a part of the abutment surface of the contact piece is in contact with the end surface of the rotating ring, a thickness gauge or the like is inserted into a gap between the other part of the abutment surface of the contact piece and the end surface of the rotating ring, and a width of the gap is measured. Then, a difference between the current rotation angle of the variable stator vane and the target maximum rotation angle is obtained from the width of the gap.

In addition, when measuring the actual rotation angle of the variable stator vane at the minimum rotation angle, the measurement device for measuring the minimum rotation angle is used. At this time, after the variable stator vane is set to the minimum rotation angle, as in the above description, the plurality of legs of the stand are brought into contact with the first link piece, and the abutment surface of the contact piece is brought into contact with the end surface of the rotating ring. It is assumed that the current rotation angle of the variable stator vane is the target minimum rotation angle when the entire abutment surface of the contact piece is in contact with the end surface of the rotating ring. On the other hand, in a case where only a part of the abutment surface of the contact piece is in contact with the end surface of the rotating ring, a thickness gauge or the like is inserted into a gap between the other part of the abutment surface of the contact piece and the end surface of the rotating ring, and a width of the gap is measured. Then, a difference between the current rotation angle of the variable stator vane and the target minimum rotation angle is obtained from the width of the gap.

### CITATION LIST

Patent Literature

[PTL 1] Japanese Unexamined Patent Application Publication No. 2015-175248

### SUMMARY OF INVENTION

### Technical Problem

In the technique described in PTL 1, a measurement device used to measure the actual rotation angle of the variable stator vane when the variable stator vane is at the maximum rotation angle and a measurement device used to measure the actual rotation angle of the variable stator vane when the variable stator vane is at the minimum rotation angle are required. Therefore, in the technique described in PTL 1, the versatility of one measurement device is low, and the device cost is high.

Thus, an object of the present disclosure is to provide a vane angle measurement device capable of improving the versatility and a vane angle measurement method using the same.

### Solution to Problem

According to one aspect of the invention for achieving the above object, a vane angle measurement device is applied to measurement of a variable stator vane of the following axial flow fluid machine.

The axial flow fluid machine includes a rotor that is rotatable about a rotor axis, a casing that covers an outer periphery of the rotor, a plurality of stator vanes that are disposed inside the casing and attached to the casing, an angle changing mechanism that is capable of rotating a variable stator vane, which is a part of the plurality of stator vanes, around a vane rotational axis extending in a radial direction with respect to the rotor axis, and an inner cylindrical member disposed on a radially inner side of the variable stator vane with respect to the rotor axis and having an annular shape about the rotor axis. Among a plurality of members constituting the angle changing mechanism, the inner cylindrical member, and the variable stator vane, a first member has an arm contact surface which is one of a variable surface that rotates around the vane rotational axis with the rotation of the variable stator vane and an angle reference surface perpendicular to the rotor axis. Among the plurality of members constituting the angle changing mechanism, the inner cylindrical member, and the variable stator vane, a second member has a first leg contact surface which is the other of the variable surface and the angle reference surface, and a second leg contact surface which extends in a direction intersecting the first leg contact surface and faces a radially outer side with respect to the rotor axis.

A vane angle measurement device capable of measuring a rotation angle of the variable stator vane in the axial flow fluid machine includes a goniometer including a measurement arm capable of coming into contact with the arm contact surface of the first member, and a goniometer body that supports the measurement arm to be rotatable around a measurement central axis and is capable of measuring a rotation angle of the measurement arm, and a stand that supports the goniometer and is capable of coming into contact with the second member. The stand includes a substrate to which the goniometer body is attached, and a plurality of legs attached to the substrate and extending in a direction having a component in a measurement central axis direction along which the measurement central axis extends. A first leg of the plurality of legs includes a device reference surface that is capable of coming into contact with the first leg contact surface of the second member, and an arm height securing surface that is capable of coming into contact with the second leg contact surface when the device reference surface is in contact with the first leg contact surface, A second leg of the plurality of legs has a second contact end that is capable of coming into contact with the second leg contact surface at a position spaced apart from the arm height securing surface of the first leg when the device reference surface is in contact with the first leg contact surface and the arm height securing surface is in contact with the second leg contact surface, and is a leg that is capable of changing a length from the substrate to the second contact end to adjust an inclination of the substrate such that the measurement central axis is parallel to the vane rotational axis.

In the present aspect, since the goniometer body can measure the rotation angle of the measurement arm, it is not necessary to change the goniometer in the vane angle measurement device when measuring the rotation angle of the variable stator vane set to the maximum rotation angle and when measuring the rotation angle of the variable stator vane set to the minimum rotation angle. In addition, in the present aspect, it is possible to measure the rotation angle of the variable stator vane that is set to the maximum rotation angle and the rotation angle of the variable stator vane that is set to the minimum rotation angle by replacing only some components among the components constituting the stand of the vane angle measurement device.

Therefore, in the present aspect, the versatility of the vane angle measurement device can be improved.

In addition, in the present aspect, since the labor of inserting a thickness gauge or the like between a part of the device and a part of the measurement target can be omitted, the labor required when measuring the rotation angle of the variable stator vane can be reduced.

According to another aspect of the invention for achieving the above object, a vane angle measurement method is a vane angle measurement method for measuring, by using the vane angle measurement device according to the one aspect, a rotation angle of the variable stator vane.

The inner cylindrical member is provided as a gas path surface forming cylinder that has a cylindrical shape about the rotor axis, and that has an outer peripheral surface and an end surface that is connected to an end of the outer peripheral surface in a rotor axis direction along which the rotor axis extends and that is perpendicular to the rotor axis, the outer peripheral surface being located on the radially inner side of the variable stator vane with respect to the rotor axis.

The vane angle measurement method includes performing a disposition step of disposing the vane angle measurement device and an angle reading step of reading an angle indicated by the goniometer body after the disposition step.

In the disposition step, the device reference surface of the first leg is brought into contact with the first leg contact surface of the second member, the arm height securing surface of the first leg is brought into contact with the second leg contact surface of the second member, the second contact end of the second leg is brought into contact with the second leg contact surface of the second member, and thereafter the length from the substrate to the second contact end is changed as necessary to adjust an inclination of the substrate such that the measurement central axis is parallel to the vane rotational axis, and the measurement arm is brought into contact with the arm contact surface of the first member.

The first member is provided as the variable stator vane. The arm contact surface of the first member is provided as a pressure surface of the variable stator vane. The second member is provided as the gas path surface forming cylinder. The first leg contact surface of the second member is provided as the end surface of the gas path surface forming cylinder. The second leg contact surface of the second member is provided as the outer peripheral surface of the gas path surface forming cylinder.

According to still another aspect of the invention for achieving the above object, a vane angle measurement method is a vane angle measurement method for measuring, by using the vane angle measurement device according to the one aspect, a rotation angle of the variable stator vane.

The inner cylindrical member is provided as a seal ring that has a cylindrical shape about the rotor axis, and that has an outer peripheral surface and an end surface that is connected to an end of the outer peripheral surface in a rotor axis direction along which the rotor axis extends and that is perpendicular to the rotor axis, the outer peripheral surface being located on the radially inner side of the variable stator vane with respect to the rotor axis. The seal ring supports the variable stator vane such that the variable stator vane is rotatable about the vane rotational axis.

The vane angle measurement method includes performing a disposition step of disposing the vane angle measurement device and an angle reading step of reading an angle indicated by the goniometer body after the disposition step.

In the disposition step, the device reference surface of the first leg is brought into contact with the first leg contact surface of the second member, the arm height securing surface of the first leg is brought into contact with the second leg contact surface of the second member, the second contact end of the second leg is brought into contact with the second leg contact surface of the second member, and thereafter the length from the substrate to the second contact end is changed as necessary to adjust an inclination of the substrate such that the measurement central axis is parallel to the vane rotational axis, and the measurement arm is brought into contact with the arm contact surface of the first member.

The first member is provided as the variable stator vane. The arm contact surface of the first member is provided as a pressure surface of the variable stator vane. The second member is provided as the seal ring. The first leg contact surface of the second member is provided as the end surface of the seal ring. The second leg contact surface of the second member is provided as the outer peripheral surface of the seal ring.

According to still another aspect of the invention for achieving the above object, a vane angle measurement method is a vane angle measurement method for measuring, by using the vane angle measurement device according to the one aspect, a rotation angle of the variable stator vane.

The angle changing mechanism includes an outer rotary shaft that is attached to an end of the variable stator vane on the radially outer side with respect to the rotor axis, and that has a cylindrical shape about the vane rotational axis, a first link piece that is fixed to the outer rotary shaft and that extends in the radial direction with respect to the vane rotational axis, and a rotating ring that is disposed on the radially outer side of the casing with respect to the rotor axis, that has an annular shape about the rotor axis, and that is rotatable about the rotor axis. The first link piece has a link side surface that extends in the radial direction with respect to the vane rotational axis and in a vane rotational axis direction along which the vane rotational axis extends, and a link outer surface that extends in a direction intersecting the link side surface and that faces the radially outer side with respect to the rotor axis. The rotating ring has a ring end surface perpendicular to the rotor axis.

The vane angle measurement method includes performing a disposition step of disposing the vane angle measurement device and an angle reading step of reading an angle indicated by the goniometer body after the disposition step.

In the disposition step, the device reference surface of the first leg is brought into contact with the first leg contact surface of the second member, the arm height securing surface of the first leg is brought into contact with the second leg contact surface of the second member, the second contact end of the second leg is brought into contact with the second leg contact surface of the second member, and thereafter the length from the substrate to the second contact end is changed as necessary to adjust an inclination of the substrate such that the measurement central axis is parallel to the vane rotational axis, and the measurement arm is brought into contact with the arm contact surface of the first member.

The first member is provided as the rotating ring. The arm contact surface of the first member is provided as the ring end surface of the rotating ring. The second member is provided as the first link piece. The first leg contact surface of the second member is provided as the link side surface of the first link piece. The second leg contact surface of the second member is provided as the link outer surface of the first link piece.

### Advantageous Effects of Invention

According to one aspect of the present disclosure, it is possible to improve the versatility of the vane angle measurement device.

### BRIEF DESCRIPTION OF DRAWINGS

FIG. 1 is a schematic cross-sectional view of a gas turbine including an axial flow fluid machine according to an embodiment of the present disclosure.

FIG. 2 is a cross-sectional view of a main part of a compressor, which is the axial flow fluid machine according to the embodiment of the present disclosure.

FIG. 3 is a cross-sectional view taken along line III-III in FIG. 2.

FIG. 4 is a perspective view of a vane angle measurement device according to a first embodiment of the present disclosure.

FIG. 5 is a side view of a vane angle measurement device according to the first embodiment of the present disclosure.

FIG. 6 is an enlarged view of part VI in FIG. 5.

FIG. 7 is a flowchart showing an execution procedure of a vane angle measurement method according to the first embodiment of the present disclosure.

FIG. 8 is a perspective view of the vane angle measurement device when a minimum rotation angle is measured according to the first embodiment of the present disclosure.

FIG. 9 is a plan view of the vane angle measurement device when a minimum rotation angle is measured according to the first embodiment of the present disclosure.

FIG. 10 is a perspective view of the vane angle measurement device when a maximum rotation angle is measured according to the first embodiment of the present disclosure.

FIG. 11 is a plan view of the vane angle measurement device when a maximum rotation angle is measured according to the first embodiment of the present disclosure.

FIG. 12 is a side view of a second leg in a modification example according to the present disclosure.

FIG. 13 is a perspective view of a vane angle measurement device according to a second embodiment of the present disclosure.

FIG. 14 is a perspective view of the vane angle measurement device when a minimum rotation angle is measured according to the second embodiment of the present disclosure.

FIG. 15 is a plan view of the vane angle measurement device when a minimum rotation angle is measured according to the second embodiment of the present disclosure.

FIG. 16 is a perspective view of the vane angle measurement device when a maximum rotation angle is measured according to the second embodiment of the present disclosure.

FIG. 17 is a plan view of the vane angle measurement device when a maximum rotation angle is measured according to the second embodiment of the present disclosure.

### DESCRIPTION OF EMBODIMENTS

Various embodiments and modification examples of the vane angle measurement device and the vane angle measurement method according to the present disclosure will be described with reference to the drawings.

### Embodiment of Axial Flow Fluid Machine

An embodiment of an axial flow fluid machine to which the vane angle measurement device according to the present disclosure is applied will be described with reference to the drawings.

The axial flow fluid machine in the present embodiment is a part of a gas turbine. Therefore, a gas turbine including the axial flow fluid machine will be described.

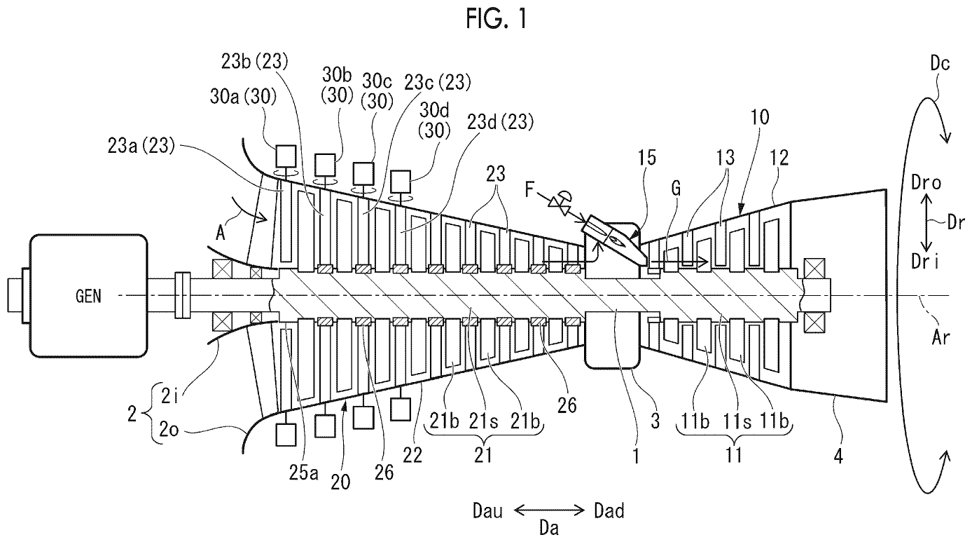

As shown in FIG. 1, the gas turbine includes a compressor 20 that is capable of compressing air A to generate compressed air, a combustor 15 that is capable of combusting fuel F in the compressed air to generate a combustion gas G, a turbine 10 that is driven by the combustion gas G having a high temperature and a high pressure, an intake casing 2 that is capable of guiding the air A to the compressor 20, an exhaust casing 4 through which an exhaust gas, which is the combustion gas G exhausted from the turbine 10, flows, and an intermediate casing 3.

The compressor 20 includes a compressor rotor 21 that is rotatable about a rotor axis Ar, a compressor casing 22 that covers the compressor rotor 21, and a plurality of compressor stator vane rows 23. The turbine 10 has a turbine rotor 11 that is rotatable about the rotor axis Ar, a turbine casing 12 that covers the turbine rotor 11, and a plurality of turbine stator vane rows 13. In addition, in the following, a direction along which the rotor axis Ar extends is referred to as a rotor axis direction Da, one side in the rotor axis direction Da is referred to as an axial upstream side Dau, and the other side in the rotor axis direction Da is referred to as an axial downstream side Dad. In addition, a circumferential direction around the rotor axis Ar is simply referred to as a circumferential direction De. In addition, a direction perpendicular to the rotor axis Ar is a radial direction Dr, a side approaching the rotor axis Ar in the radial direction Dr is a radially inner side Dri, and a side opposite to the radially inner side Dri is a radially outer side Dro.

The compressor 20 is disposed on the axial upstream side Dau with respect to the turbine 10. The compressor rotor 21 has a compressor rotor shaft 21s that extends in the rotor axis direction Da about the rotor axis Ar, and a plurality of compressor rotor blade rows 21b that are attached to the compressor rotor shaft 21s. The plurality of compressor rotor blade rows 21b are arranged in the rotor axis direction Da. Each compressor rotor blade row 21b is composed of a plurality of rotor blades arranged in the circumferential direction Dc. The plurality of compressor stator vane rows 23 are arranged in the rotor axis direction Da. Each compressor stator vane row 23 is composed of a plurality of stator vanes arranged in the circumferential direction Dc. Each of the compressor rotor blade rows 21b is disposed between any two of the compressor stator vane rows 23 that are adjacent to each other in the rotor axis direction Da, among the plurality of compressor stator vane rows 23. A space between the inner peripheral side of the compressor casing 22 and the outer peripheral side of the compressor rotor shaft 21s forms an annular air compression passage about the rotor axis Ar.

Among the plurality of compressor stator vane rows 23, all of the plurality of stator vanes constituting a first stator vane row 23a which is the compressor stator vane row 23 on the most axial upstream side Dau, the plurality of stator vanes constituting a second stator vane row 23b which is the compressor stator vane row 23 adjacent to the axial downstream side Dad of the first stator vane row 23a, the plurality of stator vanes constituting a third stator vane row 23c which is the compressor stator vane row 23 adjacent to the axial downstream side Dad of the second stator vane row 23b, and the plurality of stator vanes constituting a fourth stator vane row 23d which is the compressor stator vane row 23 adjacent to the axial downstream side Dad of the third stator vane row 23c are variable stator vanes. Since the plurality of stator vanes constituting the first stator vane row 23a are variable stator vanes for adjusting the flow rate of the air flowing into the compressor casing 22, the plurality of stator vanes are called inlet guide vane (IGV).

The turbine rotor 11 includes a turbine rotor shaft 11s extending in the rotor axis direction Da about the axis Ar, and a plurality of turbine rotor blade rows 11b attached to the turbine rotor shaft 11s. The plurality of turbine rotor blade rows 11b are arranged in the rotor axis direction Da. Each turbine rotor blade row 11b is composed of the plurality of rotor blades arranged in the circumferential direction Dc. Any one turbine stator vane row 13 among the plurality of turbine stator vane rows 13 is disposed on each axial upstream side Dau of the plurality of turbine rotor blade rows 11b. Each turbine stator vane row 13 is attached to the inside of the turbine casing 12. Each turbine stator vane row 13 is composed of the plurality of stator vanes arranged in the circumferential direction Dc.

The intermediate casing 3 is disposed between the compressor casing 22 and the turbine casing 12 in the rotor axis direction Da. An end of the intermediate casing 3 on the axial upstream side Dau is connected to an end of the compressor casing 22 on the axial downstream side Dad. An end of the intermediate casing 3 on the axial downstream side Dad is connected to an end of the turbine casing 12 on the axial upstream side Dau. The combustor 15 is attached to the intermediate casing 3.

The intake casing 2 is connected to an end of the compressor casing 22 on the axial upstream side Dau. The intake casing 2 includes an intake inner casing 2i and an intake outer casing 2o. The intake inner casing 2i has a cylindrical shape about the rotor axis Ar, and covers a portion on the axial upstream side Dau with respect to the first stator vane row 23a in the compressor rotor shaft 21s. The intake inner casing 2i is formed to gradually face the radially outer side Dro toward the axial upstream side Dau. The intake outer casing 2o has a tubular shape about the rotor axis Ar and is disposed at an interval on the radially outer side Dro with respect to the intake inner casing 2i. An end of the intake outer casing 2o on the axial downstream side Dad is connected to an end of the compressor casing 22 on the axial upstream side Dau. The intake outer casing 2o is also formed to gradually face the radially outer side Dro toward the axial upstream side Dau. In the radial direction Dr, a space between the intake inner casing 2i and the intake outer casing 2o forms an annular air passage that guides air to a compressed air passage in the compressor casing 22.

The exhaust casing 4 has a tubular shape about the rotor axis Ar, and is connected to an end of the turbine casing 12 on the axial downstream side Dad. A space on the inner peripheral side of the exhaust casing 4 forms an exhaust passage through which an exhaust gas, which is the combustion gas G exhausted from the turbine 10, flows.

The compressor rotor 21 and the turbine rotor 11 are located on the same rotor axis Ar, and are connected to each other to form a gas turbine rotor 1. For example, a rotor of a generator GEN is connected to the gas turbine rotor 1.

As described above, both the compressor 20 and the turbine 10 are axial flow fluid machines. The axial flow fluid machine to be targeted in the present embodiment is the compressor 20 having a plurality of variable stator vanes.

The compressor 20 further includes a gas path surface forming cylinder 25, a plurality of seal rings 26, and a plurality of angle changing mechanisms 30.

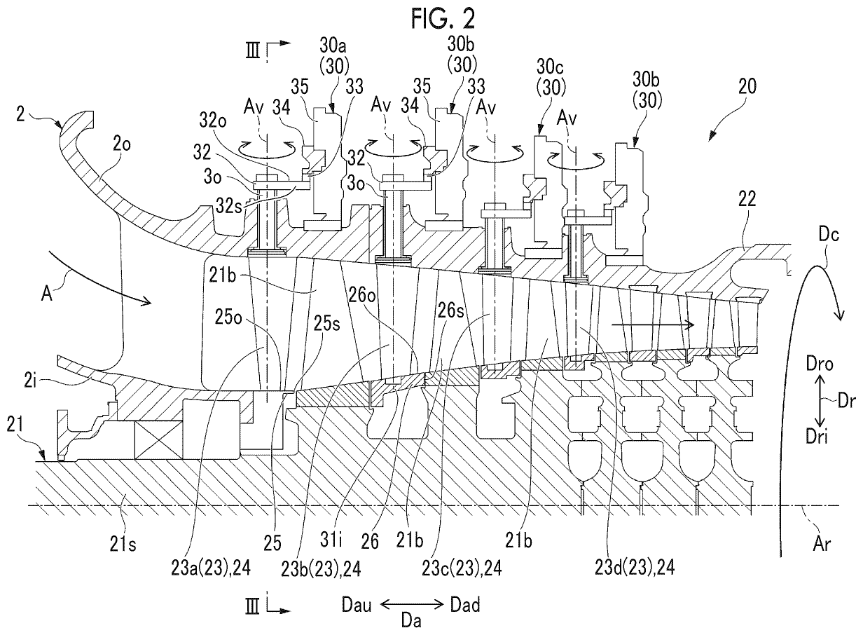

As shown in FIG. 2, the gas path surface forming cylinder 25 is disposed on the radially inner side Dri of the plurality of variable stator vanes 24 constituting the first stator vane row 23a, and is an annular member about the rotor axis Ar. The gas path surface forming cylinder 25 has an outer peripheral surface 25o and an end surface 25s that is connected to an end on the axial downstream side Dad in the outer peripheral surface 25o and that is perpendicular to the rotor axis Ar. An end of the gas path surface forming cylinder 25 on the axial upstream side Dau and an end of the intake inner casing 2i on the axial downstream side Dad face each other in the rotor axis direction Da. The outer peripheral surface 25o of the gas path surface forming cylinder 25 defines a part of an edge on the radially inner side Dri in the annular compressed air passage.

Each of the plurality of seal rings 26 is disposed on the radially inner side Dri of each of the plurality of compressor stator vane rows 23 excluding the first stator vane row 23a, and is an annular member about the rotor axis Ar. Each of the seal rings 26 has a cylindrical shape about the rotor axis Ar, and has an outer peripheral surface 26o and an end surface 26s that is connected to an end of the outer peripheral surface 26o on the axial downstream side Dad and that is perpendicular to the rotor axis Ar. Each seal ring 26 serves to seal between the stator vane and the compressor rotor shaft 21s.

An inner rotary shaft 3li that has a cylindrical shape about a vane rotational axis Av of each of the plurality of variable stator vanes 24 is attached to the radially inner side Dri of the plurality of variable stator vanes 24 constituting the second stator vane row 23b, the plurality of variable stator vanes 24 constituting the third stator vane row 23c, and the plurality of variable stator vanes 24 constituting the fourth stator vane row 23d. The seal ring 26 disposed on the radially inner side Dri of the plurality of variable stator vanes 24 supports the inner rotary shaft 31i of each of the plurality of variable stator vanes 24 to be rotatable about the vane rotational axis Av of each of the plurality of variable stator vanes 24. The vane rotational axis Av of each of the plurality of variable stator vanes 24 is an axis extending in the radial direction Dr with respect to the rotor axis Ar.

The gas path surface forming cylinder 25 disposed on the radially inner side Dri of the plurality of variable stator vanes 24 constituting the first stator vane row 23a, the seal ring 26 disposed on the radially inner side Dri of the plurality of variable stator vanes 24 constituting the second stator vane row 23b, the seal ring 26 disposed on the radially inner side Dri of the plurality of variable stator vanes 24 constituting the third stator vane row 23c, and the seal ring 26 disposed on the radially inner side Dri of the plurality of variable stator vanes 24 constituting the fourth stator vane row 23d form an annular inner cylindrical member.

The plurality of angle changing mechanisms 30 include a first angle changing mechanism 30a, a second angle changing mechanism 30b, a third angle changing mechanism 30c, and a fourth angle changing mechanism 30d.

The first angle changing mechanism 30a is a mechanism that rotates each of the plurality of variable stator vanes 24 constituting the first stator vane row 23a around a vane rotational axis Av extending in the radial direction Dr with respect to the rotor axis Ar. The second angle changing mechanism 30b is a mechanism that rotates each of the plurality of variable stator vanes 24 constituting the second stator vane row 23b around a vane rotational axis Av extending in the radial direction Dr with respect to the rotor axis Ar. The third angle changing mechanism 30c is a mechanism that rotates each of the plurality of variable stator vanes 24 constituting the third stator vane row 23c around a vane rotational axis Av extending in the radial direction Dr with respect to the rotor axis Ar. The fourth angle changing mechanism 30d is a mechanism that rotates each of the plurality of variable stator vanes 24 constituting the fourth stator vane row 23d around a vane rotational axis Av extending in the radial direction Dr with respect to the rotor axis Ar.

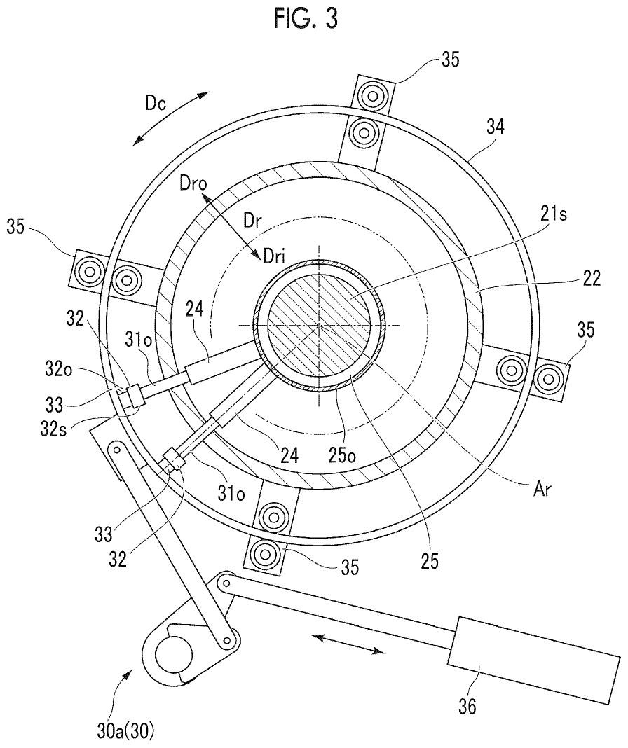

As shown in FIGS. 2 and 3, each angle changing mechanism 30 includes an outer rotary shaft 31o, a first link piece 32, a second link piece 33, a rotating ring 34, a ring support portion 35, and a ring rotation mechanism 36. The outer rotary shaft 31o, the first link piece 32, and the second link piece 33 are provided for each of the plurality of variable stator vanes 24 constituting each of the first stator vane row 23a, the second stator vane row 23b, the third stator vane row 23c, and the fourth stator vane row 23d.

The outer rotary shaft 31o is attached on the radially outer side Dro of the variable stator vane 24 and has a columnar shape around the vane rotational axis Av of the variable stator vane 24. The first link piece 32 is fixed to the outer rotary shaft 31o and extends in the radial direction with respect to the vane rotational axis Av. The first link piece 32 includes a link side surface 32s that extends in the radial direction with respect to the vane rotational axis Av and in a vane rotational axis direction Dv along which the vane rotational axis Av extends, and a link outer surface 32o that extends in a direction intersecting the link side surface 32s and that faces the radially outer side Dro with respect to the rotor axis Ar. The rotating ring 34 has an annular shape about the rotor axis Ar and is disposed on an outer peripheral side of the compressor casing 22. The rotating ring 34 has a ring end surface 34s perpendicular to the rotor axis Ar. The second link piece 33 is pin-joined to the first link piece 32 and is pin-joined to the rotating ring 34. The ring support portion 35 is fixed to the outer peripheral surface of the compressor casing 22.

The ring support portion 35 rotatably supports the rotating ring 34 about the rotor axis Ar. The ring rotation mechanism 36 is a mechanism that rotates the rotating ring 34 about the rotor axis Ar.

### First Embodiment of Vane Angle Measurement Device

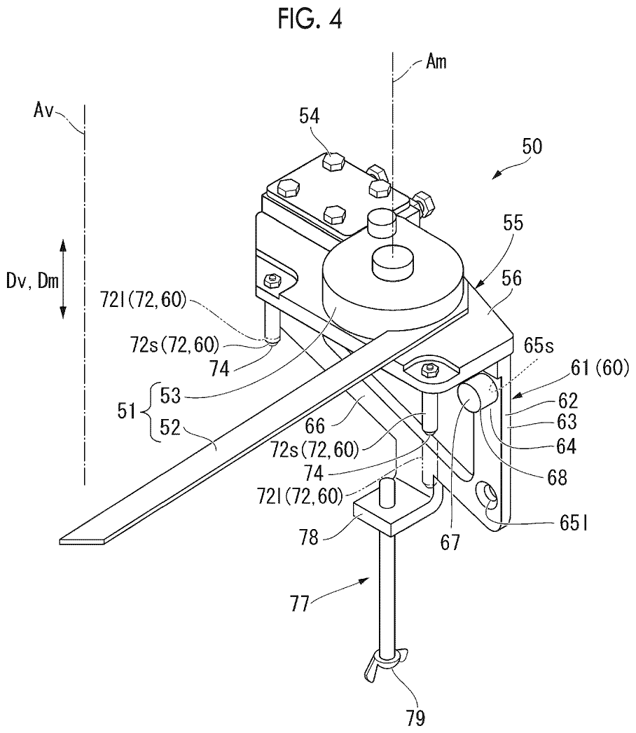

A first embodiment of the vane angle measurement device according to the present disclosure will be described with reference to FIGS. 4 to 12.

As shown in FIGS. 4, 5, 8, and 10, the vane angle measurement device 50 in the present embodiment is a device for measuring the rotation angle of the portion on the radially inner side Dri of the plurality of variable stator vanes 24 constituting the first stator vane row 23a described above.

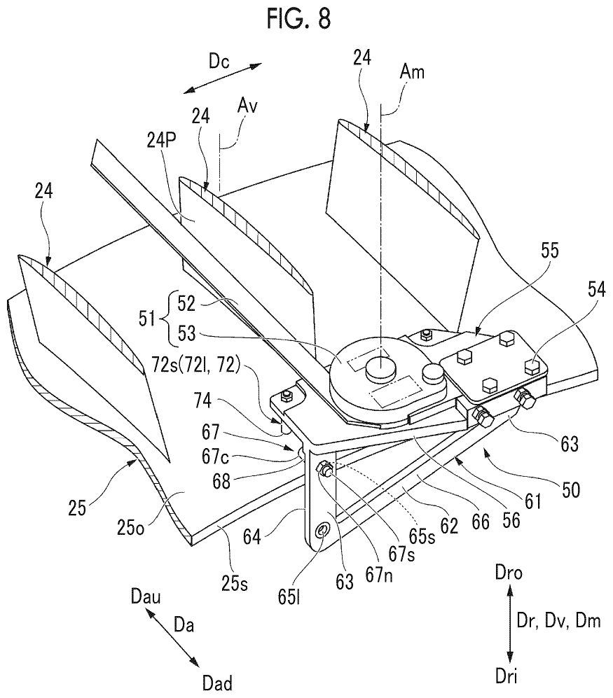

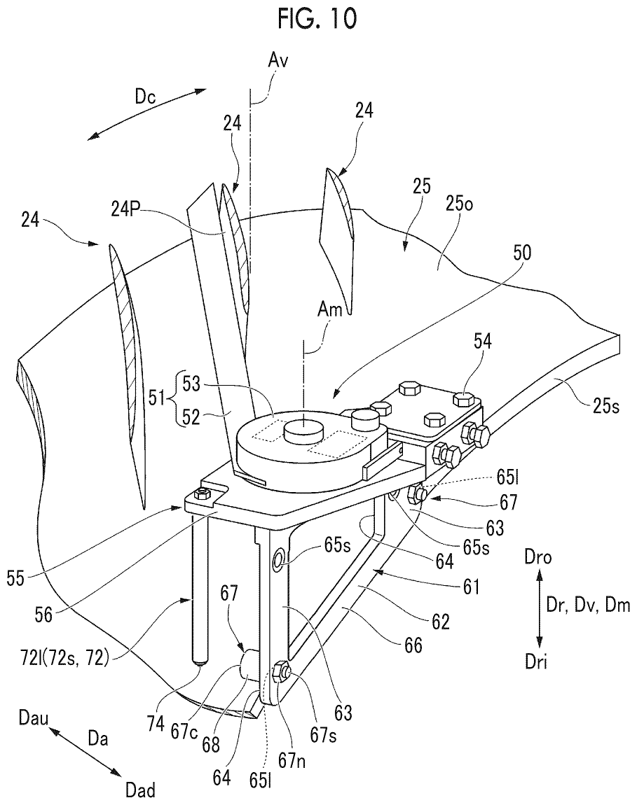

Here, hereinafter, the variable stator vane 24 rotatable around the vane rotational axis Av may be expressed as a first member. In addition, the gas path surface forming cylinder 25, which is an inner cylindrical member having the outer peripheral surface 25o and the end surface 25s, may be referred to as a second member. A pressure surface 24p (refer to FIGS. 8 and 10) of the variable stator vane 24 may be expressed as a variable surface or an arm contact surface of the first member. In some cases, the end surface 25s of the gas path surface forming cylinder 25 may be expressed as an angle reference surface or a first leg contact surface of the second member, and the outer peripheral surface 25o of the gas path surface forming cylinder 25 may be expressed as a second leg contact surface of the second member.

The vane angle measurement device 50 in the present embodiment includes a goniometer 51 and a stand 55 that supports the goniometer 51.

The goniometer 51 includes a measurement arm 52 that can come into contact with the pressure surface 24p of the variable stator vane 24, which is the variable surface or the arm contact surface of the first member, and a goniometer body 53 that supports the measurement arm 52 so as to be rotatable around a measurement central axis Am and that can measure a rotation angle of the measurement arm 52.

The stand 55 has a substrate 56 to which the goniometer body 53 is attached by a screw 54 or the like, a plurality of legs 60 attached to the substrate 56, and a clamping member 77.

All of the plurality of legs 60 extend from the substrate 56 in a measurement central axis direction Dm. The measurement central axis direction Dm is a direction along which the measurement central axis Am of the goniometer body 53 attached to the substrate 56 extends. The plurality of legs 60 include a first leg 61 and two second legs 72.

The first leg 61 includes a first leg body 62 and two height adjustment ends 67. The first leg body 62 has two first leg portions 63 extending from the substrate 56 in the measurement central axis direction Dm, and a beam 66 connecting the ends of the two first leg portions 63. The two first leg portions 63 are separated from each other in the radial direction with respect to the measurement central axis Am. Each of the two first leg portions 63 is formed with a device reference surface 64 that can come into contact with the end surface 25s of the gas path surface forming cylinder 25, which is the angle reference surface or the first leg contact surface of the second member, a minimum angle measurement hole 65s, and a maximum angle measurement hole 65l. The device reference surfaces 64 formed on the two first leg portions 63 are all located on one virtual plane parallel to the measurement central axis Am. Both the minimum angle measurement hole 65s and the maximum angle measurement hole 65l formed in each first leg portion 63 penetrate the first leg portion 63 in a direction perpendicular to the device reference surface 64. A position of the minimum angle measurement hole 65s formed in one first leg portion 63 of the two first leg portions 63 in the measurement central axis direction Dm is different from a position of the minimum angle measurement hole 65s formed in the other first leg portion 63 in the measurement central axis direction Dm. In addition, a position of the maximum angle measurement hole 65l formed in one first leg portion 63 in the measurement central axis direction Dm is different from the position of the maximum angle measurement hole 65l formed in the other first leg portion 63 in the measurement central axis direction Dm.

Each of the two height adjustment ends 67 has a contact column 67c having a columnar shape, a screw 67s extending from an end surface of the contact column 67c, and a locking nut 67n that can be screwed onto the screw 67s. The screws 67s of the two height adjustment ends 67 can be inserted into the maximum angle measurement hole 65l and the minimum angle measurement hole 65s formed in each of the two first leg portions 63. The height adjustment end 67 is attached to the first leg portion 63 by inserting the screw 67s of the height adjustment end 67 into the maximum angle measurement hole 65l or the minimum angle measurement hole 65s of the first leg portion 63 and then screwing the locking nut 67n onto the screw 67s. The outer peripheral surface of the contact column 67c of the height adjustment end 67 forms the arm height securing surface 68 that can come into contact with the outer peripheral surface 25o of the gas path surface forming cylinder 25, which is the second leg contact surface, when the device reference surface 64 comes into contact with the end surface 25s of the gas path surface forming cylinder 25, which is the first leg contact surface.

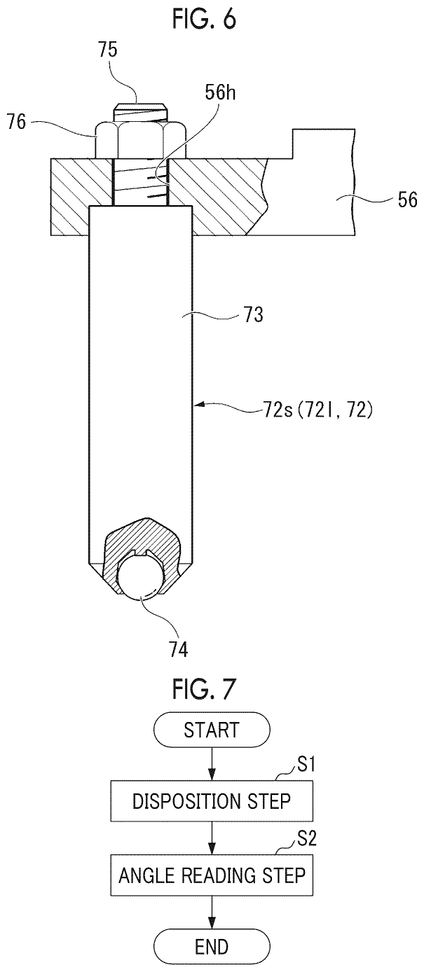

As shown in FIG. 6, each of the two second legs 72 includes a columnar second leg body 73, a ball 74 as a second contact end supported by an end of the second leg body 73 on a tip side, a screw 75 extending from an end of the second leg body 73 on a base end side, and a locking nut 76 that can be screwed onto the screw 75. The second leg body 73 rotatably supports the ball 74 about the center of the ball 74. The second leg 72 is attached to the substrate 56 by inserting the screw 75 of the second leg 72 into a second leg hole 56h formed in the substrate 56 and then screwing the locking nut 76 onto the screw 75. When the device reference surface 64 is in contact with the end surface 25s of the gas path surface forming cylinder 25, which is the first leg contact surface, and the arm height securing surface 68 is in contact with the outer peripheral surface 25o of the gas path surface forming cylinder 25, which is the second leg contact surface, the ball 74, which is the second contact end of the second leg 72 attached to the substrate 56, can come into contact with the outer peripheral surface 25o of the gas path surface forming cylinder 25, which is the second leg contact surface at a position separated from the arm height securing surface 68 of the first leg 61 in a direction perpendicular to the device reference surface 64.

Both of the two second legs 72 have a maximum angle measurement replacement leg 72l and a minimum angle measurement replacement leg 72s. A length of the maximum angle measurement replacement leg 72l is different from a length of the minimum angle measurement replacement leg 72s. For this reason, a length from the substrate 56 to the second contact end 74 when the maximum angle measurement replacement leg 72l is used as the second leg 72 is different from a length from the substrate 56 to the second contact end 74 when the minimum angle measurement replacement leg 72s is used as the second leg 72.

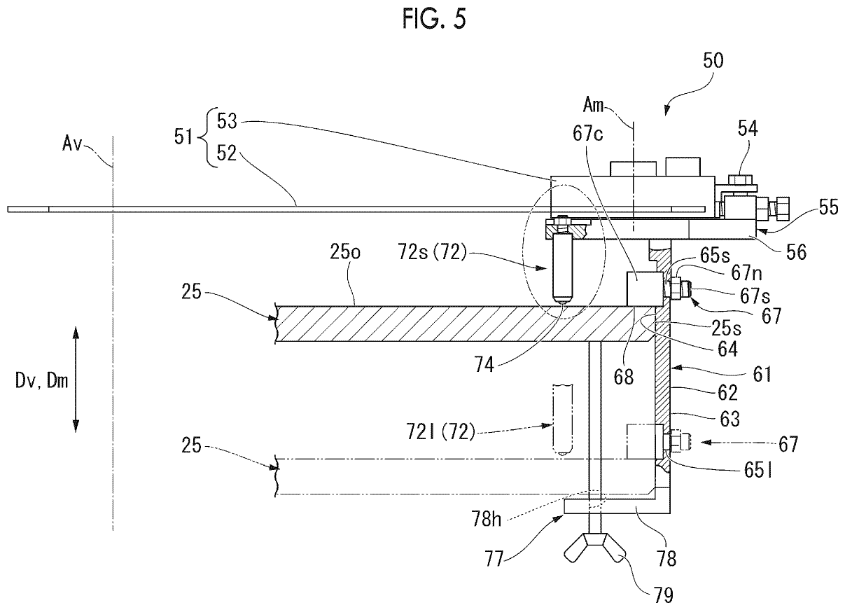

As shown in FIGS. 4 and 5, the clamping member 77 includes a bracket 78 extending in a direction perpendicular to the device reference surface 64 from the beam 66 of the first leg body 62, and a wing screw 79.

A female screw hole 78h penetrating in the measurement central axis direction Dm is formed in the bracket 78. The wing screw 79 can be screwed into the female screw hole 78h. The wing screw 79 screwed into the female screw hole 78h can clamp the gas path surface forming cylinder 25 which is the second member between the arm height securing surface 68 of the first leg 61 and the second contact end 74 of the second leg 72.

Next, a procedure for measuring the rotation angle of the portion on the radially inner side Dri of the variable stator vane 24 constituting the first stator vane row 23a will be described according to the flowchart shown in FIG. 7.

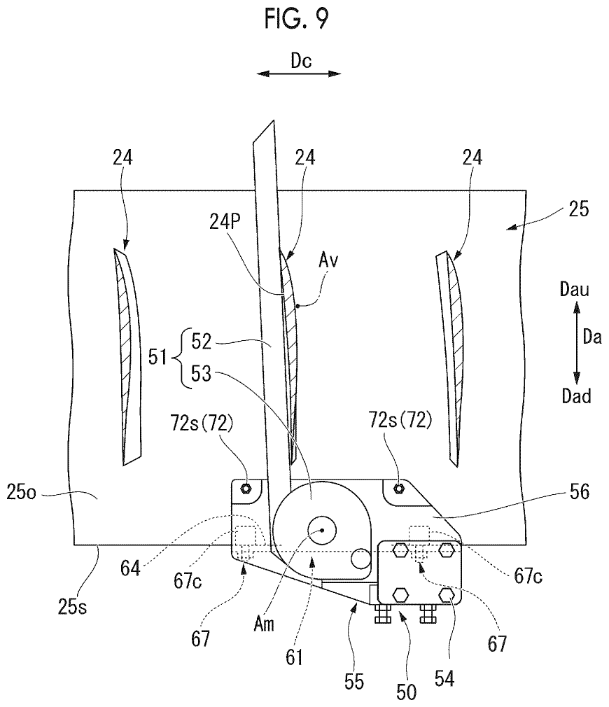

First, as shown in FIGS. 8 and 9, the first angle changing mechanism 30a is operated such that each of the plurality of variable stator vanes 24 constituting the first stator vane row 23a has the minimum rotation angle. The rotation angle of the variable stator vane 24 is the angle of the variable stator vane 24 with reference to the rotor axis Ar perpendicular to the end surfaces 25s and 26s of the gas path forming surface which is the angle reference surface.

Next, the vane angle measurement device 50 described above is disposed at a position along a portion on the radially inner side Dri of one variable stator vane 24 of the plurality of variable stator vanes 24 (disposition step S1).

In the disposition step S1, first, the height adjustment end 67 is attached to each of the two minimum angle measurement holes 65s of the first leg body 62. Further, the minimum angle measurement replacement leg 72s as the second leg 72 is attached to the substrate 56.

Next, the device reference surface 64 of the first leg 61 is brought into contact with the end surface 25s of the gas path surface forming cylinder 25, which is the first leg contact surface of the second member, and the arm height securing surface 68 of the height adjustment end 67 of the first leg 61 is brought into contact with the outer peripheral surface 25o of the gas path surface forming cylinder 25, which is the second leg contact surface of the second member. Further, the second contact end 74 of the minimum angle measurement replacement leg 72s as the second leg 72 is brought into contact with the outer peripheral surface 25o of the gas path surface forming cylinder 25, which is the second leg contact surface of the second member. As a result, the measurement central axis Am of the goniometer body 53 attached to the substrate 56 becomes parallel to the vane rotational axis Av of the variable stator vane 24. In other words, the substrate 56 is perpendicular to the vane rotational axis Av of the variable stator vane 24.

In a process of contacting the device reference surface 64 of the first leg 61 with the end surface 25s of the gas path surface forming cylinder 25 and contacting the arm height securing surface 68 of the first leg 61 and the second contact end 74 of the minimum angle measurement replacement leg 72s with the outer peripheral surface 25o of the gas path surface forming cylinder 25, the stand 55 may be moved relative to the gas path surface forming cylinder 25. In the present embodiment, since the arm height securing surface 68 of the first leg 61 is the outer peripheral surface of the contact column 67c of the height adjustment end 67 and the second contact end 74 of the second leg 72 is the rotatable ball 74, the outer peripheral surface 25o of the gas path surface forming cylinder 25 with which the arm height securing surface 68 and the second contact end 74 come into contact is unlikely to be damaged even when the stand 55 is moved relative to the gas path surface forming cylinder 25.

Next, the wing screw 79 of the clamping member 77 is screwed into the female screw hole 78h of the bracket 78, and the gas path surface forming cylinder 25, which is the second member, is clamped between the wing screw 79 and the arm height securing surface 68 of the first leg 61 and the second contact end 74 of the second leg 72. As a result, the stand 55 is temporarily restrained from moving relative to the gas path surface forming cylinder 25. In the present embodiment, since the wing screw 79 is used as the screw of the clamping member 77, the screw can be screwed without a tool.

Next, the measurement arm 52 of the goniometer 51 is brought into contact with the pressure surface 24p of the variable stator vane 24, which is the variable surface or the arm contact surface of the first member. Through the above-described process, the disposition step S1 is completed.

When the disposition step S1 is completed, the angle indicated by the goniometer body 53 is read (angle reading step S2).

Through the above-described process, the measurement of the actual rotation angle of the variable stator vane 24 is completed such that the actual rotation angle is the minimum rotation angle.

Assuming that the maximum angle measurement replacement leg 72l as the second leg 72 is attached to the substrate 56. In a case where the vane angle measurement device 50 is disposed at a position along the variable stator vane 24 in a state where the maximum angle measurement replacement leg 72l is attached to the substrate 56, the measurement central axis Am of the goniometer body 53 attached to the substrate 56 is inclined with respect to the vane rotational axis Av of the variable stator vane 24. For this reason, the angle indicated by the goniometer body 53 in this state is different from the actual rotation angle of the variable stator vane 24. Therefore, in this case, in the disposition step S1, in order to adjust the inclination of the substrate 56 such that the measurement central axis Am is parallel to the vane rotational axis Av, the maximum angle measurement replacement leg 72l is removed from the substrate 56, and the minimum angle measurement replacement leg 72s is attached to the substrate 56.

When the measurement of the rotation angle of one variable stator vane 24 among the plurality of variable stator vanes 24 constituting the first stator vane row 23a is completed, the rotation angle of another variable stator vane 24 among the plurality of variable stator vanes 24 constituting the first stator vane row 23a is measured. In this case, as described above, the vane angle measurement device 50 in which the height adjustment end 67 is attached to each of the two minimum angle measurement holes 65s of the first leg body 62 and the minimum angle measurement replacement leg 72s as the second leg 72 is attached to the substrate 56 is used to measure the rotation angle of the other variable stator vane 24.

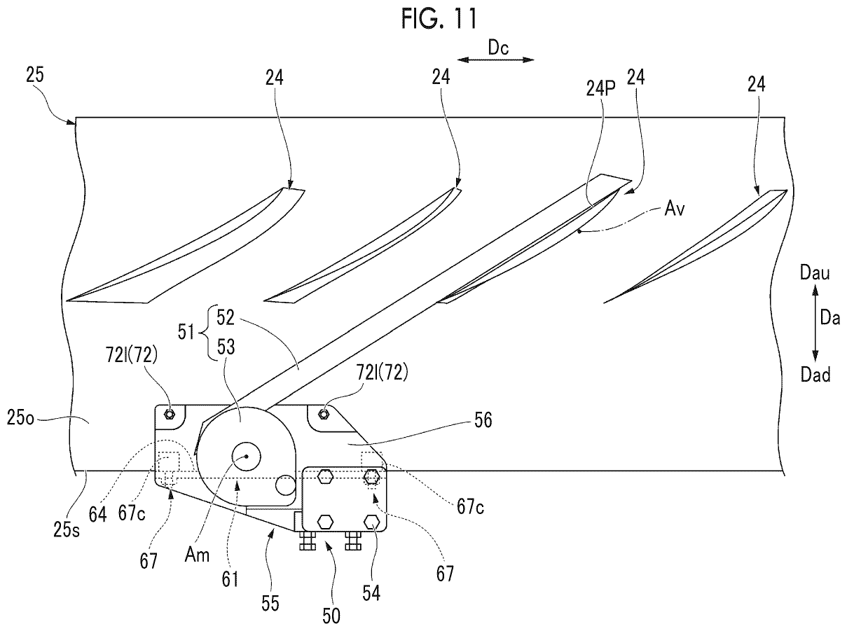

Next, as shown in FIGS. 10 and 11, the first angle changing mechanism 30a is operated such that each of the plurality of variable stator vanes 24 constituting the first stator vane row 23a has the maximum rotation angle.

Next, as in the above-described case, the vane angle measurement device 50 described above is disposed at a position along a portion on the radially inner side Dri of one variable stator vane 24 of the plurality of variable stator vanes 24 (disposition step S1).

However, in the disposition step S1, first, the height adjustment end 67 is attached to each of the two maximum angle measurement holes 65l of the first leg body 62. Further, the maximum angle measurement replacement leg 72l as the second leg 72 is attached to the substrate 56.

Next, as described above, the device reference surface 64 of the first leg 61 is brought into contact with the end surface 25s of the gas path surface forming cylinder 25, which is the first leg contact surface of the second member, and the arm height securing surface 68 of the height adjustment end 67 of the first leg 61 is brought into contact with the outer peripheral surface 25o of the gas path surface forming cylinder 25, which is the second leg contact surface of the second member. Further, the second contact end 74 of the maximum angle measurement replacement leg 72l as the second leg 72 is brought into contact with the outer peripheral surface 25o of the gas path surface forming cylinder 25, which is the second leg contact surface of the second member. As a result, the measurement central axis Am of the goniometer body 53 attached to the substrate 56 becomes parallel to the vane rotational axis Av of the variable stator vane 24.

Next, as described above, the wing screw 79 of the clamping member 77 is screwed into the female screw hole of the bracket 78, and the gas path surface forming cylinder 25, which is the second member, is clamped between the wing screw 79 and the arm height securing surface 68 of the first leg 61 and the second contact end 74 of the second leg 72.

Next, the measurement arm 52 of the goniometer 51 is brought into contact with the pressure surface 24p of the variable stator vane 24, which is the variable surface or the arm contact surface of the first member. Through the above-described process, the disposition step S1 is completed.

When the disposition step S1 is completed, the angle indicated by the goniometer body 53 is read (angle reading step S2).

Through the above-described process, the measurement of the actual rotation angle of the variable stator vane 24 is completed such that the actual rotation angle is the maximum rotation angle.

In the present embodiment, when the rotation angle of the variable stator vane 24 is measured, the measurement arm 52 of the goniometer 51 is brought into contact with the portion on the downstream side of the pressure surface 24p of the variable stator vane 24. Meanwhile, the position of the portion on the downstream side of the pressure surface 24p of the variable stator vane 24, which is set to the minimum rotation angle, in the circumferential direction De is substantially the same as the position of the vane rotational axis Av of the variable stator vane 24 in the circumferential direction De (refer to FIG. 9). On the other hand, the position of the portion on the downstream side of the pressure surface 24p of the variable stator vane 24, which is set to the maximum rotation angle, in the circumferential direction Dc is significantly different from the position of the vane rotational axis Av of the variable stator vane 24 in the circumferential direction Dc (refer to FIG. 11). Accordingly, it is necessary to change the relative positional relationship between the vane rotational axis Av and the stand 55 in the circumferential direction Dc when measuring the rotation angle of the variable stator vane 24 set to the maximum rotation angle and when measuring the rotation angle of the variable stator vane 24 set to the minimum rotation angle. Therefore, for the measurement arm 52 of the goniometer 51 to come into contact with the pressure surface 24p of the variable stator vane 24 and for the measurement central axis Am of the goniometer body 53 attached to the substrate 56 to be parallel to the vane rotational axis Av of the variable stator vane 24, it is necessary to change the lengths of the plurality of legs 60 when measuring the rotation angle of the variable stator vane 24 set to the maximum rotation angle and when measuring the rotation angle of the variable stator vane 24 set to the minimum rotation angle.

Therefore, when measuring the rotation angle of the variable stator vane 24 set to the maximum rotation angle, unlike when measuring the rotation angle of the variable stator vane 24 set to the minimum rotation angle, the height adjustment end 67 is attached to each of the two maximum angle measurement holes 65l of the first leg body 62, and the maximum angle measurement replacement leg 72l as the second leg 72 is attached to the substrate 56.

In the above-described embodiment, since the goniometer body 53 can measure the rotation angle of the measurement arm 52, it is not necessary to change the goniometer 51 in the vane angle measurement device 50 when measuring the rotation angle of the variable stator vane 24 set to the maximum rotation angle and when measuring the rotation angle of the variable stator vane 24 set to the minimum rotation angle.

In addition, in the present embodiment, among the components constituting the stand 55 of the vane angle measurement device 50, only some components can be replaced or the attachment position can be changed, so that the rotation angle of the variable stator vane 24 that is set to the maximum rotation angle and the rotation angle of the variable stator vane 24 that is set to the minimum rotation angle can be measured.

Therefore, in the present embodiment, the versatility of the vane angle measurement device 50 can be improved.

In addition, in the present embodiment, since the labor of inserting a thickness gauge or the like between a part of the device and a part of the measurement target can be omitted, the labor required when measuring the rotation angle of the variable stator vane 24 can be reduced.

Further, the stand 55 of the vane angle measurement device 50 in the present embodiment includes the clamping member 77, and can temporarily restrain the stand 55 from moving relative to the gas path surface forming cylinder 25. Therefore, for example, even in a case where the rotation angle of the variable stator vane 24 that is present below the rotor axis Ar among the plurality of variable stator vanes 24 is measured, the rotation angle indicated by the goniometer body 53 can be read by temporarily restraining the stand 55 from being relatively movable with respect to the gas path surface forming cylinder 25 by the clamping member 77 without the operator pressing the stand 55 against the gas path surface forming cylinder 25 with the hand.

### Modification Example of First Embodiment of Vane Angle Measurement Device

The vane angle measurement device 50 in the first embodiment is a device for measuring the rotation angle of the portion on the radially inner side Dri of the plurality of variable stator vanes 24 constituting the first stator vane row 23a. However, the rotation angle of the portion on the radially inner side Dri of the plurality of variable stator vanes 24 constituting the second stator vane row 23b, the rotation angle of the portion on the radially inner side Dri of the plurality of variable stator vanes 24 constituting the third stator vane row 23c, and the rotation angle of the portion on the radially inner side Dri of the plurality of variable stator vanes 24 constituting the fourth stator vane row 23d can be measured by using the vane angle measurement device having the same configuration as the vane angle measurement device 50 in the first embodiment. However, in these cases, it is necessary to change the lengths of the plurality of legs of the vane angle measurement device from the lengths of the plurality of legs 60 of the vane angle measurement device 50 in the present embodiment.

Therefore, as described below, the versatility of the vane angle measurement device 50 can be further improved by changing the vane angle measurement device 50 in the present embodiment.

(1) In addition to the minimum angle measurement hole 65s for the first stator vane row 23a and the maximum angle measurement hole 65l for the first stator vane row 23a, any of a minimum angle measurement hole for the second stator vane row 23b and a maximum angle measurement hole for the second stator vane row 23b, a minimum angle measurement hole for the third stator vane row 23c and a maximum angle measurement hole for the third stator vane row 23c, and a minimum angle measurement hole for the fourth stator vane row 23d and a maximum angle measurement hole for the fourth stator vane row 23d is further formed in the first leg body 62.

(2) As the second leg 72, in addition to the minimum angle measurement replacement leg 72s for the first stator vane row 23a and the maximum angle measurement replacement leg 72l for the first stator vane row 23a, any of a minimum angle measurement replacement leg for the second stator vane row 23b and a maximum angle measurement replacement leg for the second stator vane row 23b, a minimum angle measurement replacement leg for the third stator vane row 23c and a maximum angle measurement replacement leg for the third stator vane row 23c, and a minimum angle measurement replacement leg for the fourth stator vane row 23d and a maximum angle measurement replacement leg for the fourth stator vane row 23d is further prepared.

In a case where the rotation angle of the portion on the radially inner side Dri of the plurality of variable stator vanes 24 constituting the second stator vane row 23b, the rotation angle of the portion on the radially inner side Dri of the plurality of variable stator vanes 24 constituting the third stator vane row 23c, and the rotation angle of the portion on the radially inner side Dri of the plurality of variable stator vanes 24 constituting the fourth stator vane row 23d are measured, the seal ring 26, which is the inner cylindrical member having the outer peripheral surface 26o and the end surface 26s, serves as the second member. In addition, the end surface 26s of the seal ring 26 serves as the angle reference surface or the first leg contact surface of the second member, and the outer peripheral surface 26o of the seal ring 26 serves as the second leg contact surface of the second member. Therefore, in this case, in the disposition step S1, the device reference surface 64 of the first leg 61 is brought into contact with the end surface 26s of the seal ring 26, which is the first leg contact surface of the second member, and the arm height securing surface 68 of the first leg 61 and the second contact end 74 of the second leg 72 are brought into contact with the outer peripheral surface 26o of the seal ring 26, which is the second leg contact surface of the second member.

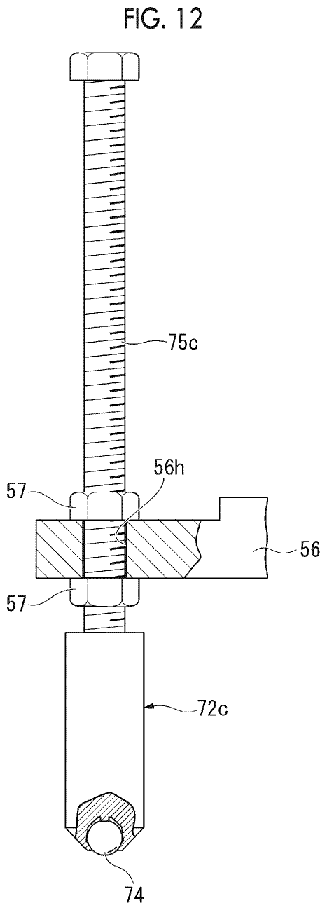

In addition, a length adjustment leg may be used as the second leg 72 instead of the minimum angle measurement replacement leg 72s and the maximum angle measurement replacement leg 72l. As shown in FIG. 12, the length adjustment leg 72c includes a columnar second leg body 73, a ball 74 as a second contact end supported at an end on a tip side of the second leg body 73, and a male screw 75c extending from an end on a base end side of the second leg body 73. The length of the male screw 75c of the length adjustment leg 72c is much longer than the lengths of the screws 75 of the minimum angle measurement replacement leg 72s and the maximum angle measurement replacement leg 72l shown in FIG. 6. A second leg hole 56h into which the male screw 75c of the length adjustment leg 72c can be inserted is formed in the substrate 56. Further, an adjustment nut 57 into which the male screw 75c of the length adjustment leg 72c can be screwed is fixed to the substrate 56. The female screw hole of the adjustment nut 57 communicates with the second leg hole 56h of the substrate 56.

The length adjustment leg 72c can be attached to the substrate 56 by inserting the male screw 75c of the length adjustment leg 72c into the second leg hole 56h of the substrate 56 and screwing the male screw 75c of the length adjustment leg 72c into the adjustment nut 57 fixed to the substrate 56. At this time, the amount of screwing of the male screw 75c of the length adjustment leg 72c with respect to the adjustment nut 57 fixed to the substrate 56 is changed, so that the amount of protrusion of the length adjustment leg 72c from the substrate 56 in the measurement central axis direction Dm can be adjusted. Therefore, the length adjustment leg 72c is used as the second leg 72, and thus it is not necessary to prepare the two replacement legs 72s and 72l having different lengths from each other. In addition, by preparing only the length adjustment leg 72c as the second leg 72, it is also possible to measure the rotation angle of the plurality of variable stator vanes 24 constituting the second stator vane row 23b, the rotation angle of the plurality of variable stator vanes 24 constituting the third stator vane row 23c, and the rotation angle of the plurality of variable stator vanes 24 constituting the fourth stator vane row 23d.

### Second Embodiment of Vane Angle Measurement Device

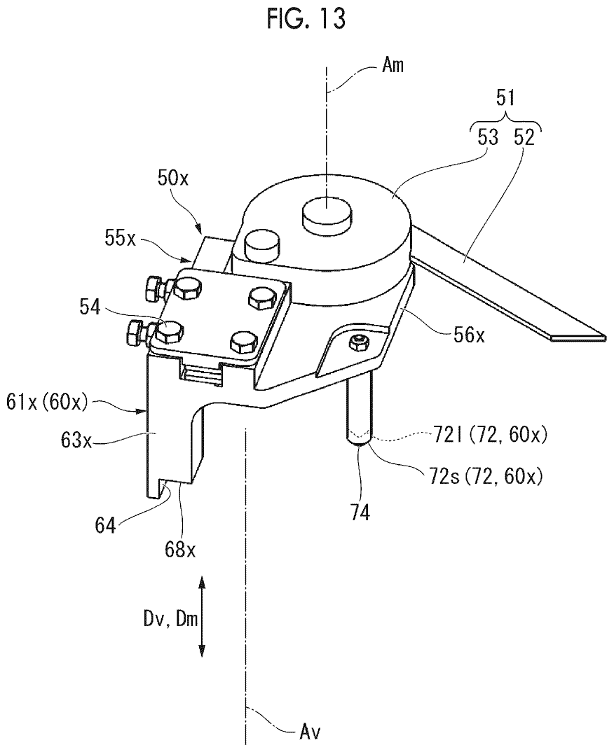

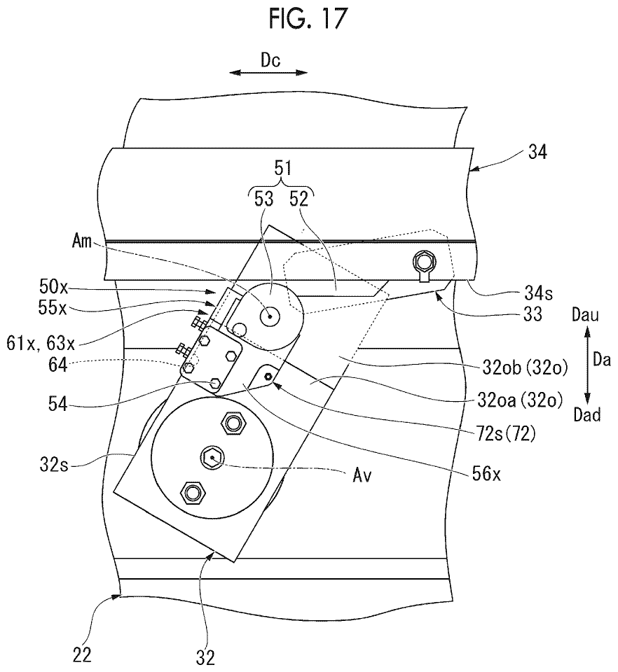

A second embodiment of the vane angle measurement device according to the present disclosure will be described with reference to FIGS. 13 to 18.

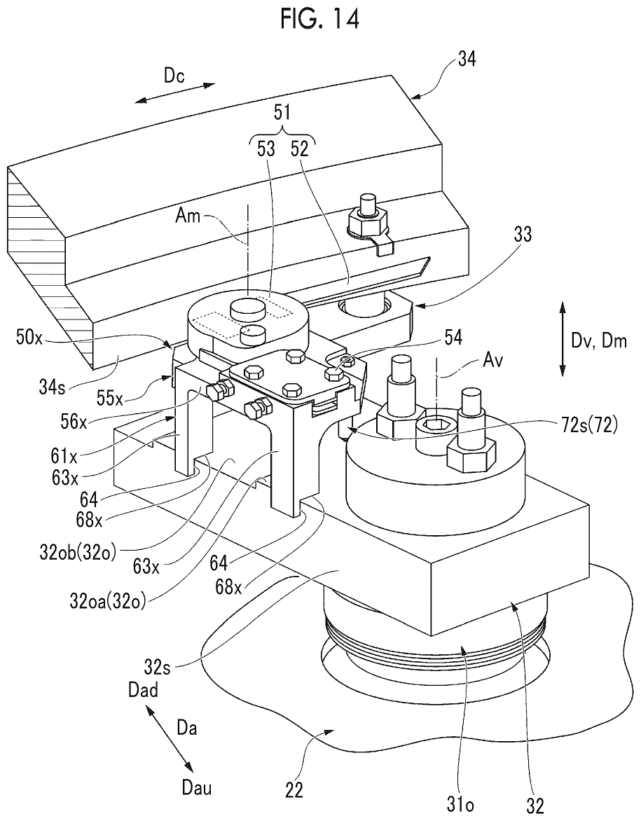

As shown in FIGS. 13 and 14, a vane angle measurement device 50x in the present embodiment is a device for measuring a rotation angle at a position on the radially outer side Dro of the plurality of variable stator vanes 24 constituting the first stator vane row 23a described above.

Here, hereinafter, the rotating ring 34 of the first angle changing mechanism 30a may be expressed as a first member. In addition, the first link piece 32 of the first angle changing mechanism 30a may be expressed as a second member. In addition, the ring end surface 34s of the rotating ring 34 may be expressed as an angle reference surface or an arm contact surface of the first member. In some cases, the link side surface 32s of the first link piece 32 may be expressed as a variable surface or a first leg contact surface of the second member, and the link outer surface 32o of the first link piece 32 may be expressed as a second leg contact surface of the second member.

The vane angle measurement device 50x in the present embodiment also includes the goniometer 51 and the stand 55x that supports the goniometer 51, as in the vane angle measurement device 50 in the first embodiment.

The goniometer 51 includes a measurement arm 52 that can come into contact with the ring end surface 34s of the rotating ring 34, which is the angle reference surface of the first member or the arm contact surface, and a goniometer body 53 that supports the measurement arm 52 to be rotatable around the measurement central axis Am and that can measure the rotation angle of the measurement arm 52, as in the goniometer 51 of the vane angle measurement device 50 in the first embodiment.

The stand 55x has a substrate 56x to which the goniometer body 53 is attached by a screw 54 or the like, and a plurality of legs 60x attached to the substrate 56x.

All of the plurality of legs 60x extend from the substrate 56x in the measurement central axis direction Dm. The plurality of legs 60x include a first leg 61x and a second leg 72.

The first leg 61x has two first leg portions 63x that are fixed to the substrate 56x and that extend from the substrate 56x in the measurement central axis direction Dm. The two first leg portions 63x are separated from each other in the radial direction with respect to the measurement central axis Am. The two first leg portions 63x are formed with two device reference surfaces 64 capable of coming into contact with the link side surface 32s of the first link piece 32, which is a variable surface or a first leg contact surface of the second member, and an arm height securing surface 68x capable of coming into contact with the link outer surface 32o of the first link piece 32, which is a second leg contact surface of the second member. Each of the device reference surfaces 64 formed on the two first leg portions 63x is located on one virtual plane.

Incidentally, as shown in FIG. 14, the link outer surface 32o of the first link piece 32 has a first link outer surface 32oa and a second link outer surface 32ob. The first link outer surface 32oa is formed at a position intersecting the vane rotational axis Av, and the second link outer surface 32ob is formed at a position separated from the vane rotational axis Av in the radial direction with respect to the vane rotational axis Av. Both the first link outer surface 32oa and the second link outer surface 32ob extend in a direction intersecting the link side surface 32s and face the radially outer side Dro with respect to the rotor axis Ar. For this reason, the second link outer surface 32ob is parallel to the first link outer surface 32oa. In addition, a position of the second link outer surface 32ob in the vane rotational axis direction Dv is different from a position of the first link outer surface 32oa in the vane rotational axis direction Dv. Therefore, the second link outer surface 32ob forms a stepped surface with respect to the first link outer surface 32oa.

The arm height securing surface 68x formed on one first leg portion 63x of the two first leg portions 63x can come into contact with the first link outer surface 32oa in the link outer surface 32o. In addition, when the arm height securing surface 68x formed on the other first leg portion 63x of the two first leg portions 63x is in contact with the first link outer surface 32oa, the arm height securing surface 68x formed on the other first leg portion 63x can be in contact with the second link outer surface 32ob of the link outer surface 32o. Therefore, the position of the arm height securing surface 68x formed on the other first leg portion 63x in the measurement central axis direction Dm is different from the position of the arm height securing surface 68x formed on the one first leg portion 63x in the measurement central axis direction Dm.

The arm height securing surface 68x in the present embodiment is a surface formed on the two first leg portions 63x fixed to the substrate 56x. Therefore, unlike the arm height securing surfaces 68 in the first embodiment, the position of the measurement central axis direction Dm cannot be changed.

As described above, the first leg 61x of the stand 55x in the present embodiment has the device reference surface 64 that can come into contact with the first leg contact surface of the second member, and the arm height securing surface 68x that can come into contact with the second leg contact surface when the device reference surface 64 is in contact with the first leg contact surface, as in the first leg 61 of the first embodiment.

The second leg 72 is the same as the second leg 72 in the first embodiment described with reference to FIG. 6.

Therefore, when the device reference surface 64 is in contact with the link side surface 32s of the first link piece 32, which is the first leg contact surface, and the arm height securing surface 68x is in contact with the link outer surface 32o of the first link piece 32, which is the second leg contact surface, the ball 74 that is the second contact end of the second leg 72 attached to the substrate 56x can come into contact with the link outer surface 32o of the first link piece 32, which is the second leg contact surface, at a position separated from the device reference surface 64 in a direction perpendicular to the arm height securing surface 68x of the first leg 61x.

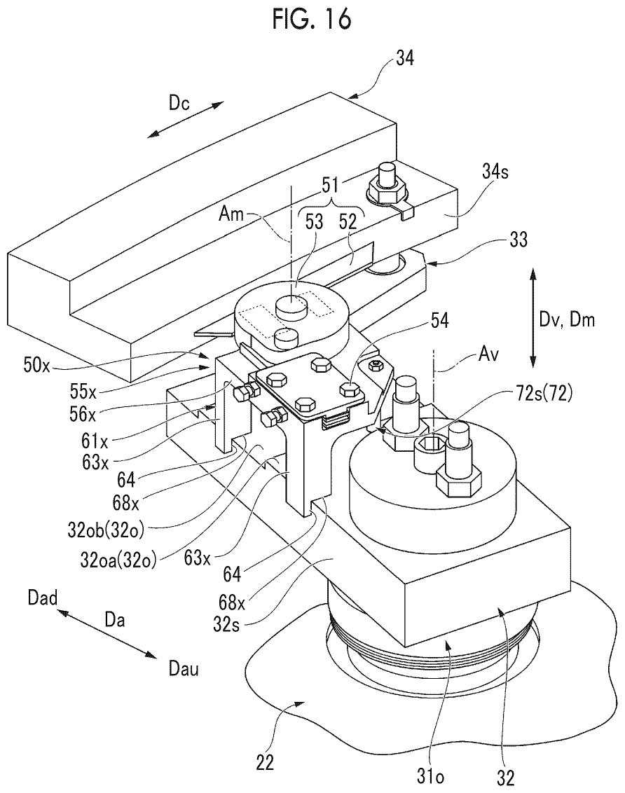

As in the second leg 72 in the first embodiment, the second leg 72 has a maximum angle measurement replacement leg 72l (refer to FIG. 16) and a minimum angle measurement replacement leg 72s (refer to FIG. 14). A length of the maximum angle measurement replacement leg 72l is different from a length of the minimum angle measurement replacement leg 72s. For this reason, a length from the substrate 56x to the second contact end 74 when the maximum angle measurement replacement leg 72l is used as the second leg 72 is different from a length from the substrate 56x to the second contact end 74 when the minimum angle measurement replacement leg 72s is used as the second leg 72.

As described above, the second leg 72 of the stand 55x in the present embodiment has the second contact end 74 that can come into contact with the second leg contact surface at a position separated from the arm height securing surface 68x of the first leg 61x, when the device reference surface 64 comes into contact with the first leg contact surface and the arm height securing surface 68x comes into contact with the second leg contact surface, as in the second leg 72 of the first embodiment. Further, the second leg 72 of the stand 55x in the present embodiment is the leg 60x in which the length from the substrate 56x to the second contact end 74 is changeable, as in the second leg 72 in the first embodiment, so that the inclination of the substrate 56x is adjustable such that the measurement central axis Am is parallel to the vane rotational axis Av.

Next, a procedure for measuring the rotation angle at the position on the radially outer side Dro in the plurality of variable stator vanes 24 constituting the first stator vane row 23a will be described.

First, the first angle changing mechanism 30a is operated such that each of the plurality of variable stator vanes 24 constituting the first stator vane row 23a has the minimum rotation angle.

Then, the disposition step S1 and the angle reading step S2 are executed, as in the measurement procedure in the first embodiment described with reference to FIG. 7.

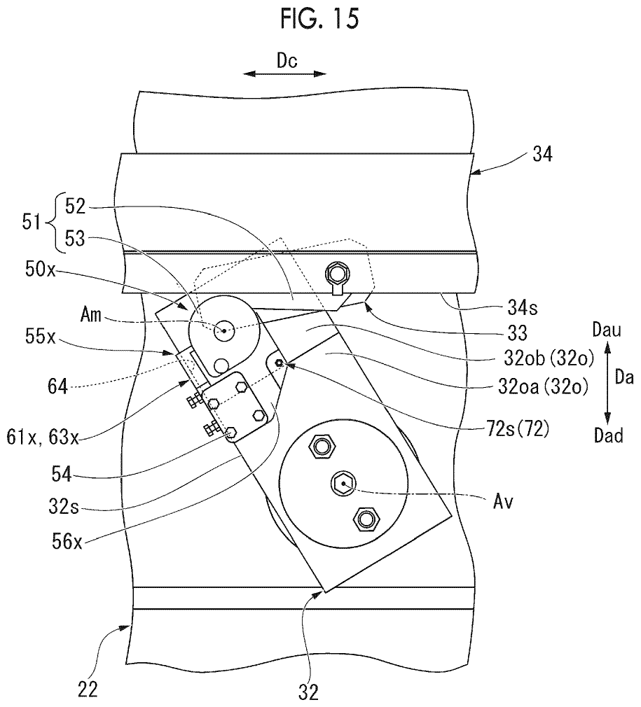

In the disposition step S1, as shown in FIGS. 14 and 15, the vane angle measurement device 50x is disposed at a position along the first link piece 32 with respect to one variable stator vane 24 of the plurality of variable stator vanes 24.

In the disposition step S1, first, the minimum angle measurement replacement leg 72s as the second leg 72 is attached.

Next, the device reference surface 64 of each of the two first leg portions 63x is brought into contact with the link side surface 32s of the first link piece 32, which is the first leg contact surface of the second member. Further, the arm height securing surface 68x of one first leg portion 63x is brought into contact with the first link outer surface 32oa of the first link piece 32, which is the second leg contact surface of the second member, and the arm height securing surface 68x of the other first leg portion 63x is brought into contact with the second link outer surface 32ob of the first link piece 32, which is the second leg contact surface of the second member, Further, the second contact end 74 of the minimum angle measurement replacement leg 72s as the second leg 72 is brought into contact with the second link outer surface 32ob of the first link piece 32, which is the second leg contact surface of the second member.

As a result, the measurement central axis Am of the goniometer body 53 attached to the substrate 56x becomes parallel to the vane rotational axis Av of the variable stator vane 24. In other words, the substrate 56x is perpendicular to the vane rotational axis Av of the variable stator vane 24.

In a process of contacting the second contact end 74 of the minimum angle measurement replacement leg 72s as the second leg 72 with the second link outer surface 32ob of the first link piece 32, the stand 55x may be moved relative to the first link piece 32. In the present embodiment, since the second contact end of the second leg 72 is the rotatable ball 74, even when the stand 55x is moved relative to the first link piece 32, the second link outer surface 32ob with which the ball 74 comes into contact is hardly scratched.

Next, the measurement arm 52 of the goniometer 51 is brought into contact with the ring end surface 34s of the rotating ring 34, which is the angle reference surface or the arm contact surface of the first member. Through the above-described process, the disposition step S1 is completed.

When the disposition step S1 is completed, the angle reading step S2 is executed. That is, the angle indicated by the goniometer body 53 is read.

Through the above-described process, the measurement of the actual rotation angle of the variable stator vane 24 is completed such that the actual rotation angle is the minimum rotation angle.

Assuming that the maximum angle measurement replacement leg 72l as the second leg 72 is attached to the substrate 56x. In a case where the vane angle measurement device 50x is disposed at a position along the first link piece 32 in a state where the maximum angle measurement replacement leg 72l is attached to the substrate 56x, the measurement central axis Am of the goniometer body 53 attached to the substrate 56x is inclined with respect to the vane rotational axis Av of the variable stator vane 24. For this reason, the angle indicated by the goniometer body 53 in this state is different from the actual rotation angle of the variable stator vane 24. Therefore, in this case, in the disposition step S1, in order to adjust the inclination of the substrate 56x such that the measurement central axis Am is parallel to the vane rotational axis Av, the maximum angle measurement replacement leg 72l is removed from the substrate 56x, and the minimum angle measurement replacement leg 72s is attached to the substrate 56x.

When the measurement of the rotation angle of one variable stator vane 24 among the plurality of variable stator vanes 24 constituting the first stator vane row 23a is completed, the rotation angle of another variable stator vane 24 among the plurality of variable stator vanes 24 constituting the first stator vane row 23a is measured. In this case, as described above, the rotation angle of the other variable stator vane 24 is measured by using the vane angle measurement device 50x in which the minimum angle measurement replacement leg 72s as the second leg 72 is attached to the substrate 56x.

Next, the first angle changing mechanism 30a is operated such that each of the plurality of variable stator vanes 24 constituting the first stator vane row 23a has a maximum rotation angle.

Next, as in the above-described case, the vane angle measurement device 50x is disposed as shown in FIGS. 15 and 16 (disposition step S1).

However, in the disposition step S1, first, the maximum angle measurement replacement leg 72l as the second leg 72 is attached to the substrate 56x.

Next, the device reference surface 64 of each of the two first leg portions 63x is brought into contact with the link side surface 32s of the first link piece 32, which is the first leg contact surface of the second member. Further, the arm height securing surface 68x of one first leg portion 63x is brought into contact with the first link outer surface 32oa of the first link piece 32, which is the second leg contact surface of the second member, and the arm height securing surface 68x of the other first leg portion 63x is brought into contact with the second link outer surface 32ob of the first link piece 32, which is the second leg contact surface of the second member. Further, the second contact end 74 of the maximum angle measurement replacement leg 72l as the second leg 72 is brought into contact with the first link outer surface 32oa of the first link piece 32, which is the second leg contact surface of the second member. As a result, the measurement central axis Am of the goniometer body 53 attached to the substrate 56x becomes parallel to the vane rotational axis Av of the variable stator vane 24. In other words, the substrate 56x is perpendicular to the vane rotational axis Av of the variable stator vane 24.

Next, the measurement arm 52 of the goniometer 51 is brought into contact with the ring end surface 34s of the rotating ring 34, which is the angle reference surface or the arm contact surface of the first member. Through the above-described process, the disposition step S1 is completed.

When the disposition step S1 is completed, the angle indicated by the goniometer body 53 is read (angle reading step S2).

Through the above-described process, the measurement of the actual rotation angle of the variable stator vane 24 is completed such that the actual rotation angle is the maximum rotation angle.

In the present embodiment, when measuring the rotation angle of the variable stator vane 24, the measurement arm 52 of the goniometer 51 is brought into contact with the ring end surface 34s of the rotating ring 34. For this reason, the distance from the ring end surface 34s of the rotating ring 34 to the measurement central axis Am of the goniometer body 53 in the direction perpendicular to the link side surface 32s need to be the same when measuring the rotation angle of the variable stator vane 24 set to be the minimum rotation angle and when measuring the rotation angle of the variable stator vane 24 set to be the maximum rotation angle. On the other hand, the distance from the ring end surface 34s of the rotating ring 34 to the specific position of the first link piece 32 in the direction perpendicular to the link side surface 32s is different when measuring the rotation angle of the variable stator vane 24 set to be the minimum rotation angle and when measuring the rotation angle of the variable stator vane 24 set to be the maximum rotation angle. Therefore, it is necessary to change the relative position of the stand 55x with respect to the first link piece 32 when measuring the rotation angle of the variable stator vane 24 set to the minimum rotation angle and when measuring the rotation angle of the variable stator vane 24 set to the maximum rotation angle. Specifically, when measuring the rotation angle of the variable stator vane 24 set to the minimum rotation angle, the stand 55x is set such that the second leg 72 comes into contact with the second link outer surface 32ob of the first link piece 32, and when measuring the rotation angle of the variable stator vane 24 set to the maximum rotation angle, the stand 55x is set such that the second leg 72 comes into contact with the first link outer surface 32oa of the first link piece 32. As described above, since the second link outer surface 32ob is a stepped surface with respect to the first link outer surface 32oa, it is necessary to change the length of the second leg 72 when measuring the rotation angle of the variable stator vane 24 set to the minimum rotation angle and when measuring the rotation angle of the variable stator vane 24 set to the maximum rotation angle.

Therefore, when measuring the rotation angle of the variable stator vane 24 set to the maximum rotation angle, the maximum angle measurement replacement leg 72l as the second leg 72 is attached to the substrate 56x, unlike when measuring the rotation angle of the variable stator vane 24 set to the minimum rotation angle.

As described above, in the present embodiment, as in the first embodiment, since the goniometer body 53 can measure the rotation angle of the measurement arm 52, it is not necessary to change the goniometer 51 in the vane angle measurement device 50x when measuring the rotation angle of the variable stator vane 24 set to the maximum rotation angle and when measuring the rotation angle of the variable stator vane 24 set to the minimum rotation angle.

In addition, in the present embodiment, as in the first embodiment, only some components among the components constituting the stand 55x of the vane angle measurement device 50x can be replaced, and thus the rotation angle of the variable stator vane 24 that is set to the maximum rotation angle and the rotation angle of the variable stator vane 24 that is set to the minimum rotation angle can be measured.

Therefore, in the present embodiment, the versatility of the vane angle measurement device 50x can be improved.

In addition, in the present embodiment, as in the first embodiment, since the labor of inserting a thickness gauge or the like between a part of the device and a part of the measurement target can be omitted, the labor required when measuring the rotation angle of the variable stator vane 24 can be reduced.

### Modification Example of Second Embodiment of Vane Angle Measurement Device

The vane angle measurement device 50x in the second embodiment is a device for measuring the rotation angle at the position on the radially outer side Dro of the plurality of variable stator vanes 24 constituting the first stator vane row 23a. However, the rotation angle at the position on the radially outer side Dro of the plurality of variable stator vanes 24 constituting the second stator vane row 23b, the rotation angle at the position on the radially outer side Dro of the plurality of variable stator vanes 24 constituting the third stator vane row 23c, and the rotation angle at the position on the radially outer side Dro of the plurality of variable stator vanes 24 constituting the fourth stator vane row 23d can be measured by using the vane angle measurement device having the same configuration as the vane angle measurement device 50x in the second embodiment. However, in these cases, it is necessary to change the length of the plurality of legs 60x of the vane angle measurement device from the length of the plurality of legs 60x of the vane angle measurement device 50x in the present embodiment.

Therefore, as described below, the versatility of the vane angle measurement device 50x can be further improved by changing the vane angle measurement device 50x in the present embodiment.

(1) The first leg 61x in the present embodiment is changed to the leg 60 having the first leg body 62 and the height adjustment end 67 capable of changing the attachment position with respect to the first leg body 62, as in the first leg 61 in the first embodiment.

(2) As the second leg 72, in addition to the minimum angle measurement replacement leg 72s for the first stator vane row 23a and the maximum angle measurement replacement leg 72l for the first stator vane row 23a, any of a minimum angle measurement replacement leg for the second stator vane row 23b and a maximum angle measurement replacement leg for the second stator vane row 23b, a minimum angle measurement replacement leg for the third stator vane row 23c and a maximum angle measurement replacement leg for the third stator vane row 23c, and a minimum angle measurement replacement leg for the fourth stator vane row 23d and a maximum angle measurement replacement leg for the fourth stator vane row 23d is further prepared.

In addition, instead of the minimum angle measurement replacement leg 72s and the maximum angle measurement replacement leg 72l, the length adjustment leg 72c described with reference to FIG. 12 may be used as the second leg 72.

In addition, the stand 55x in the present embodiment may also have the clamping member 77, as in the stand 55 in the first embodiment.

### Other Modification Examples

In the above description, an example has been described in which the compressor 20 constituting a part of the gas turbine is an axial flow fluid machine and the rotation angle of the variable stator vane 24 of the compressor 20 is measured. However, the axial flow fluid machine need not be the compressor 20 that configures a part of the gas turbine as long as the axial flow fluid machine has the variable stator vane, and may be, for example, a gas compressor provided in a fluid gas liquefaction device.

In addition, the present disclosure is not limited to each of the embodiments described above. Various additions, modifications, substitutions, partial deletions, and the like can be made without departing from the conceptual idea and gist of the present invention derived from the contents defined in the claims and equivalents thereof.

### Supplementary Notes

The vane angle measurement device 50, 50x in the above-described embodiments and modification examples is understood as follows, for example.

(1) A vane angle measurement device in a first aspect is applied to measurement of a variable stator vane 24 of the following axial flow fluid machine.

The axial flow fluid machine includes a rotor 21 that is rotatable about a rotor axis Ar, a casing 22 that covers an outer periphery of the rotor 21, a plurality of stator vanes that are disposed inside the casing 22 and attached to the casing 22, an angle changing mechanism 30 that is capable of rotating variable stator vane 24, which is a part of the plurality of stator vanes, around a vane rotational axis Av extending in a radial direction Dr with respect to the rotor axis Ar, and an inner cylindrical member 25, 26 disposed on a radially inner side Dri of the variable stator vane 24 with respect to the rotor axis Ar and having an annular shape about the rotor axis Ar. Among a plurality of members constituting the angle changing mechanism 30, the inner cylindrical member 25, 26, and the variable stator vane 24, first member 24, 34 has an arm contact surface 24p, 34s which is one of a variable surface 24p, 32s that rotates around the vane rotational axis Av with the rotation of the variable stator vane 24 and an angle reference surface 25s, 26s, and 34s perpendicular to the rotor axis Ar. Among the plurality of members constituting the angle changing mechanism 30, the inner cylindrical member 25, 26, and the variable stator vane 24, a second member 32 has a first leg contact surface 25s, 26s, and 32s which is the other of the variable surface 24p, 32s and the angle reference surface 25s, 26s, and 34s, and a second leg contact surface 25o, 26o, and 32o which extends in a direction intersecting the first leg contact surface 25s, 26s, and 32s and faces a radially outer side Dro with respect to the rotor axis Ar.

A vane angle measurement device 50, 50x capable of measuring a rotation angle of the variable stator vane 24 in the axial flow fluid machine includes a goniometer 51 including a measurement arm 52 capable of coming into contact with the arm contact surface 24p, 34s of the first member 24, 34, and a goniometer body 53 that supports the measurement arm 52 to be rotatable around a measurement central axis Am and is capable of measuring a rotation angle of the measurement arm 52, and a stand 55, 55x that supports the goniometer 51 and is capable of coming into contact with the second member 32. The stand 55, 55x includes a substrate 56, 56x to which the goniometer body 53 is attached, and a plurality of legs 60, 60x attached to the substrate 56, 56x and extending in a direction having a component in a measurement central axis direction Dm along which the measurement central axis Am extends. A first leg 61, 61x of the plurality of legs 60, 60x includes a device reference surface 64 that is capable of coming into contact with the first leg contact surface 25s, 26s, and 32s of the second member 32, and an arm height securing surface 68, 68x that is capable of coming into contact with the second leg contact surface 25o, 26o, and 32o when the device reference surface 64 is in contact with the first leg contact surface 25s, 26s, and 32s. A second leg 72 of the plurality of legs 60, 60x has a second contact end 74 that is capable of coming into contact with the second leg contact surface 25o, 26o, and 32o at a position spaced apart from the arm height securing surface 68, 68x of the first leg 61, 61x when the device reference surface 64 is in contact with the first leg contact surface 25s, 26s, and 32s and the arm height securing surface 68, 68x is in contact with the second leg contact surface 25o, 26o, and 32o, and is a leg that is capable of changing a length from the substrate 56, 56x to the second contact end 74 to adjust an inclination of the substrate 56, 56x such that the measurement central axis Am is parallel to the vane rotational axis Av.

In the present aspect, since the goniometer body 53 can measure the rotation angle of the measurement arm 52, it is not necessary to change the goniometer 51 in the vane angle measurement device 50, 50x when measuring the rotation angle of the variable stator vane 24 set to the maximum rotation angle and when measuring the rotation angle of the variable stator vane 24 set to the minimum rotation angle. In addition, in the present aspect, it is possible to measure the rotation angle of the variable stator vane 24 that is set to the maximum rotation angle and the rotation angle of the variable stator vane 24 that is set to the minimum rotation angle by replacing only some components among the components constituting the stand 55, 55x of the vane angle measurement device 50, 50x.

Therefore, in the present aspect, the versatility of the vane angle measurement device 50, 50x can be improved.

In addition, in the present aspect, since the labor of inserting a thickness gauge or the like between a part of the device and a part of the measurement target can be omitted, the labor required when measuring the rotation angle of the variable stator vane 24 can be reduced.

(2) In the vane angle measurement device according to a second aspect, in the vane angle measurement device 50, 50x according to the first aspect, the second leg 72 includes a ball as the second contact end 74 and a second leg body 73 that rotatably supports the ball 74 about a center of the ball 74.

In the present aspect, even when the stand 55, 55x is relatively moved with respect to the second member 32 in a state where the second contact end 74 of the second leg 72 is in contact with the second leg contact surface 25o, 26o, and 32o of the second member 32, the second contact end 74 is formed of a rotatable ball. Therefore, it is possible to prevent the second leg contact surface 25o, 26o, and 32o of the second member 32 from being damaged.

(3) In the vane angle measurement device according to a third aspect, in the vane angle measurement device 50, 50x in the first aspect or the second aspect, the second leg 72 is provided as a plurality of replacement legs 72s and 72l.

The plurality of replacement legs 72s and 72l have different lengths from each other, and each of the plurality of replacement legs 72s and 72l can be attached to the substrate 56, 56x.

In the present aspect, the distance from the substrate 56, 56x to the second contact end 74 can be changed by changing the replacement legs 72s and 72l attached to the substrate 56, 56x.

(4) In the vane angle measurement device according to a fourth aspect, in the vane angle measurement device 50, 50x in the first aspect or the second aspect, the second leg 72 is provided as a length adjustment leg 72c.

The length adjustment leg 72c is attachable to the substrate 56, 56x such that an amount of protrusion in a direction including the measurement central axis direction Dm from the substrate 56, 56x is adjustable.

In the present aspect, the length adjustment leg 72c can change the distance from the substrate 56, 56x to the second contact end 74 by changing the amount of protrusion of the length adjustment leg 72c in the direction including the measurement central axis direction Dm from the substrate 56, 56x.

(5) In the vane angle measurement device according to a fifth aspect, in the vane angle measurement device 50 according to any one aspect of the first aspect to the fourth aspect, the first leg 61 includes a first leg body 62 having the device reference surface 64, and a height adjustment end 67 having the arm height securing surface 68 and attached to the first leg body 62 so as to be capable of changing a position of the height adjustment end in the measurement central axis direction Dm with respect to the first leg body 62.

In the present aspect, the distance from the substrate 56 to the arm height securing surface 68 can be changed by changing the attachment position of the height adjustment end 67 with respect to the first leg body 62.

(6) In the vane angle measurement device according to a sixth aspect, in the vane angle measurement device 50 according to any one of the first to fifth aspects, the stand 55 includes a clamping member 77 provided on the first leg 61 and capable of clamping the second member between the arm height securing surface 68 of the first leg 61 and the second contact end 74 of the second leg 72.

In the present aspect, the clamping member 77 can temporarily restrain the stand 55 from moving relative to the second member. Therefore, for example, even in a case where the rotation angle of the variable stator vane 24 that is present below the rotor axis Ar among the plurality of variable stator vanes 24 is measured, the rotation angle indicated by the goniometer body 53 can be read by temporarily restraining the stand 55 from being relatively movable with respect to the second member by the clamping member 77 without the operator pressing the stand 55 against the second member with the hand.

The vane angle measurement method in the above-described embodiments and modification examples is understood as follows, for example.

(7) A vane angle measurement method in a seventh aspect is a vane angle measurement method for measuring, by using the vane angle measurement device 50 according to any one of the first to sixth aspects, a rotation angle of the variable stator vane 24.

The inner cylindrical member 25 is provided as a gas path surface forming cylinder 25 that has a cylindrical shape about the rotor axis Ar, and that has an outer peripheral surface 25o and an end surface 25s that is connected to an end of the outer peripheral surface 25o in a rotor axis direction Da along which the rotor axis Ar extends and that is perpendicular to the rotor axis Ar, the outer peripheral surface 25o being located on the radially inner side Dri of the variable stator vane 24 with respect to the rotor axis Ar.

The vane angle measurement method includes a disposition step S1 of disposing the vane angle measurement device 50 and an angle reading step S2 of reading an angle indicated by the goniometer body 53 after the disposition step S1.

In the disposition step S1, the device reference surface 64 of the first leg 61 is brought into contact with the first leg contact surface 25s of the second member 25, the arm height securing surface 68 of the first leg 61 is brought into contact with the second leg contact surface 25o of the second member 25, the second contact end 74 of the second leg 72 is brought into contact with the second leg contact surface 25o of the second member 25, and thereafter the length from the substrate 56 to the second contact end 74 is changed as necessary to adjust an inclination of the substrate 56 such that the measurement central axis Am is parallel to the vane rotational axis Av, and the measurement arm 52 is brought into contact with the arm contact surface 24p of the first member 24.

The first member 24 is provided as the variable stator vane 24. The arm contact surface 24p of the first member 24 is provided as a pressure surface 24p of the variable stator vane 24. The second member 25 is provided as the gas path surface forming cylinder 25. The first leg contact surface 25s of the second member 25 is provided as the end surface 25s of the gas path surface forming cylinder 25. The second leg contact surface 25o of the second member 25 is provided as the outer peripheral surface 25o of the gas path surface forming cylinder 25.

In the present aspect, in a case where the inner cylindrical member 25 is provided as the gas path surface forming cylinder 25, the rotation angle of the portion on the radially inner side Dri of the variable stator vane 24 can be measured.

(8) A vane angle measurement method in a eighth aspect is a vane angle measurement method for measuring, by using the vane angle measurement device 50 according to any one of the first to sixth aspects, a rotation angle of the variable stator vane 24.

The inner cylindrical member 26 is provided as a seal ring 26 that has a cylindrical shape about the rotor axis Ar, and that has an outer peripheral surface 26o and an end surface 26s that is connected to an end of the outer peripheral surface 26o in a rotor axis direction Da along which the rotor axis Ar extends and that is perpendicular to the rotor axis Ar, the outer peripheral surface 26o being located on the radially inner side Dri of the variable stator vane 24 with respect to the rotor axis Ar.

The seal ring 26 supports the variable stator vane 24 such that the variable stator vane 24 is rotatable about the vane rotational axis Av.

The vane angle measurement method includes a disposition step S1 of disposing the vane angle measurement device 50 and an angle reading step S2 of reading an angle indicated by the goniometer body 53 after the disposition step S1.

In the disposition step S1, the device reference surface 64 of the first leg 61 is brought into contact with the first leg contact surface 26s of the second member 26, the arm height securing surface 68 of the first leg 61 is brought into contact with the second leg contact surface 26o of the second member 26, the second contact end 74 of the second leg 72 is brought into contact with the second leg contact surface 26o of the second member 26, and thereafter the length from the substrate 56 to the second contact end 74 is changed as necessary to adjust an inclination of the substrate 56 such that the measurement central axis Am is parallel to the vane rotational axis Av, and the measurement arm 52 is brought into contact with the arm contact surface 24p of the first member 24.

The first member 24 is provided as the variable stator vane 24. The arm contact surface 24p of the first member 24 is provided as a pressure surface 24p of the variable stator vane 24. The second member 26 is provided as the seal ring 26. The first leg contact surface 26s of the second member 26 is provided as the end surface 26s of the seal ring 26. The second leg contact surface 26o of the second member 26 is provided as the outer peripheral surface 26o of the seal ring 26.

In the present aspect, in a case where the inner cylindrical member 26 is provided as the seal ring 26, the rotation angle of the portion on the radially inner side Dri of the variable stator vane 24 can be measured.

(9) A vane angle measurement method in a ninth aspect is a vane angle measurement method for measuring, by using the vane angle measurement device 50x according to any one of the first to sixth aspects, a rotation angle of the variable stator vane 24.

The angle changing mechanism 30 includes an outer rotary shaft 31o that is attached to an end of the variable stator vane 24 on the radially outer side Dro with respect to the rotor axis Ar, and that has a cylindrical shape about the vane rotational axis Av, a first link piece 32 that is fixed to the outer rotary shaft 31o and that extends in the radial direction with respect to the vane rotational axis Av, and a rotating ring 34 that is disposed on the radially outer side Dro of the casing 22 with respect to the rotor axis Ar, that has an annular shape about the rotor axis Ar, and that is rotatable about the rotor axis Ar. The first link piece 32 includes a link side surface 32s that extends in the radial direction with respect to the vane rotational axis Av and in a vane rotational axis direction Dv along which the vane rotational axis Av extends, and a link outer surface 32o that extends in a direction intersecting the link side surface 32s and that faces the radially outer side Dro with respect to the rotor axis Ar. The rotating ring 34 has a ring end surface 34s that is perpendicular to the rotor axis Ar.

The vane angle measurement method includes performing a disposition step S1 of disposing the vane angle measurement device 50x and an angle reading step S2 of reading an angle indicated by the goniometer body 53 after the disposition step S1.

In the disposition step S1, the device reference surface 64 of the first leg 61x is brought into contact with the first leg contact surface 32s of the second member 32, the arm height securing surface 68x of the first leg 61x is brought into contact with the second leg contact surface 32o of the second member 32, the second contact end 74 of the second leg 72 is brought into contact with the second leg contact surface 32o of the second member 32, and thereafter the length from the substrate 56x to the second contact end 74 is changed as necessary to adjust an inclination of the substrate 56x such that the measurement central axis Am is parallel to the vane rotational axis Av, and the measurement arm 52 is brought into contact with the arm contact surface 34s of the first member 34.

The first member 34 is provided as the rotating ring 34. The arm contact surface 34s of the first member 34 is provided as the ring end surface 34s of the rotating ring 34. The second member 32 is provided as the first link piece 32. The first leg contact surface 32s of the second member 32 is provided as the link side surface 32s of the first link piece 32. The second leg contact surface 32o of the second member 32 is provided as the link outer surface 32o of the first link piece 32.

In the present aspect, in a case where the angle changing mechanism 30 includes the outer rotary shaft 31o, the first link piece 32, and the rotating ring 34, it is possible to measure the rotation angle at the position on the radially outer side Dro in the variable stator vane 24.

### INDUSTRIAL APPLICABILITY

According to one aspect of the present disclosure, it is possible to improve the versatility of the vane angle measurement device.

### REFERENCE SIGNS LIST

1: gas turbine rotor
2: intake casing
2i: intake inner casing
2o: intake outer casing
3: intermediate casing
4: exhaust casing
10: turbine
11: turbine rotor
11s: turbine rotor shaft
11b: turbine rotor blade row
12: turbine casing
13: turbine stator vane row
15: combustor
20: compressor (axial flow fluid machine)
21: compressor rotor
21s: compressor rotor shaft
21b: compressor rotor blade row
22: compressor casing
23: compressor stator vane row
23a: first stator vane row
23b: second stator vane row
23c: third stator vane row
23d: fourth stator vane row
24: variable stator vane (first member)
24p: pressure surface (variable surface, arm contact surface)
25: gas path surface forming cylinder (inner cylindrical member, second member)
25o: outer peripheral surface (second leg contact surface)
25s: end surface (angle reference surface, first leg contact surface)
26: seal ring (inner cylindrical member, second member)
26o: outer peripheral surface (second leg contact surface)
26s: end surface (angle reference surface, first leg contact surface)
30: angle changing mechanism
30a: first angle changing mechanism
30b: second angle changing mechanism
30c: third angle changing mechanism
30d: fourth angle changing mechanism
31i: inner rotary shaft
31o: outer rotary shaft
32: first link piece (second member)
32s: link side surface (variable surface, first leg contact surface)
32o: link outer surface (second leg contact surface)
32oa: first link outer surface (second leg contact surface)
32ob: second link outer surface (second leg contact surface)
33: second link piece
34: rotating ring (first member)
34s: ring end surface (angle reference surface, arm contact surface)
35: ring support portion
36: ring rotation mechanism
50, 50x: vane angle measurement device
51: goniometer
52: measurement arm
53: goniometer body
54: screw
55, 55x: stand
56, 56x: substrate
56h: second leg hole
57: adjustment nut
60, 60x: leg
61, 61x: first leg
62: first leg body
63, 63x: first leg portion
64: device reference surface
65s: minimum angle measurement hole
65l: maximum angle measurement hole
66: beam
67: height adjustment end
67c: contact column
68, 68x: arm height securing surface
67s: screw
67n: locking nut
72: second leg
72s: minimum angle measurement replacement leg
72l: maximum angle measurement replacement leg
72c: length adjustment leg
73: second leg body
74: ball (second contact end)
75: screw
75c: male screw
76: locking nut
77: clamping member
78: bracket
78h: female screw hole
79: wing screw
Ar: rotor axis
Av: vane rotational axis
Am: measurement central axis
Da: axis direction
Dau: axial upstream side
Dad: axial downstream side
Dr: radial direction
Dri: radially inner side
Dro: radially outer side
Dc: circumferential direction
Dv: vane rotational axis direction
Dm: measurement central axis direction

1. A vane angle measurement device capable of measuring a rotation angle of a variable stator vane in an axial flow fluid machine including
a rotor that is rotatable about a rotor axis,
a casing that covers an outer periphery of the rotor,
a plurality of stator vanes that are disposed inside the casing and attached to the casing,
an angle changing mechanism that is capable of rotating a variable stator vane, which is a part of the plurality of stator vanes, around a vane rotational axis extending in a radial direction with respect to the rotor axis, and
an inner cylindrical member disposed on a radially inner side of the variable stator vane with respect to the rotor axis and having an annular shape about the rotor axis,
in which among a plurality of members constituting the angle changing mechanism, the inner cylindrical member, and the variable stator vane, a first member has an arm contact surface which is one of a variable surface that rotates around the vane rotational axis with the rotation of the variable stator vane and an angle reference surface perpendicular to the rotor axis, and
among the plurality of members constituting the angle changing mechanism, the inner cylindrical member, and the variable stator vane, a second member has a first leg contact surface which is the other of the variable surface and the angle reference surface, and a second leg contact surface which extends in a direction intersecting the first leg contact surface and faces a radially outer side with respect to the rotor axis, the vane angle measurement device comprising:
a goniometer including a measurement arm capable of coming into contact with the arm contact surface of the first member, and a goniometer body that supports the measurement arm to be rotatable around a measurement central axis and is capable of measuring a rotation angle of the measurement arm; and
a stand that supports the goniometer and is capable of coming into contact with the second member,
wherein the stand includes a substrate to which the goniometer body is attached, and a plurality of legs attached to the substrate and extending in a direction having a component in a measurement central axis direction along which the measurement central axis extends,
a first leg of the plurality of legs includes a device reference surface that is capable of coming into contact with the first leg contact surface of the second member, and an arm height securing surface that is capable of coming into contact with the second leg contact surface when the device reference surface is in contact with the first leg contact surface, and
a second leg of the plurality of legs has a second contact end that is capable of coming into contact with the second leg contact surface at a position spaced apart from the arm height securing surface of the first leg when the device reference surface is in contact with the first leg contact surface and the arm height securing surface is in contact with the second leg contact surface, and is a leg that is capable of changing a length from the substrate to the second contact end to adjust an inclination of the substrate such that the measurement central axis is parallel to the vane rotational axis.

2. The vane angle measurement device according to claim 1,
wherein the second leg includes a ball as the second contact end and a second leg body that rotatably supports the ball about a center of the ball.

3. The vane angle measurement device according to claim 1,
wherein the second leg is provided as a plurality of replacement legs,
the plurality of replacement legs respectively have different lengths, and
each of the replacement legs is attachable to the substrate.

4. The vane angle measurement device according to claim 1,
wherein the second leg is provided as a length adjustment leg, and
the length adjustment leg is attachable to the substrate such that an amount of protrusion of the length adjustment leg from the substrate in a direction including the measurement central axis direction is adjustable.

5. The vane angle measurement device according to claim 1,
wherein the first leg includes a first leg body having the device reference surface, and a height adjustment end having the arm height securing surface and attached to the first leg body so as to be capable of changing a position of the height adjustment end in the measurement central axis direction with respect to the first leg body.

6. The vane angle measurement device according to claim 1,
wherein the stand includes a clamping member provided on the first leg and capable of clamping the second member between the arm height securing surface of the first leg and the second contact end of the second leg.

7. A vane angle measurement method for measuring, by using the vane angle measurement device according to claim 1, a rotation angle of the variable stator vane, in which the inner cylindrical member is provided as a gas path surface forming cylinder that has a cylindrical shape about the rotor axis, and that has an outer peripheral surface and an end surface that is connected to an end of the outer peripheral surface in a rotor axis direction along which the rotor axis extends and that is perpendicular to the rotor axis, the outer peripheral surface being located on the radially inner side of the variable stator vane with respect to the rotor axis, the vane angle measurement method comprising:
a disposition step of disposing the vane angle measurement device; and
an angle reading step of reading an angle indicated by the goniometer body after the disposition step,
wherein in the disposition step,
the device reference surface of the first leg is brought into contact with the first leg contact surface of the second member,
the arm height securing surface of the first leg is brought into contact with the second leg contact surface of the second member,
the second contact end of the second leg is brought into contact with the second leg contact surface of the second member, and thereafter the length from the substrate to the second contact end is changed as necessary to adjust an inclination of the substrate such that the measurement central axis is parallel to the vane rotational axis, and
the measurement arm is brought into contact with the arm contact surface of the first member,
the first member is provided as the variable stator vane,
the arm contact surface of the first member is provided as a pressure surface of the variable stator vane,
the second member is provided as the gas path surface forming cylinder,
the first leg contact surface of the second member is provided as the end surface of the gas path surface forming cylinder, and
the second leg contact surface of the second member is provided as the outer peripheral surface of the gas path surface forming cylinder.

8. A vane angle measurement method for measuring, by using the vane angle measurement device according to claim 1, a rotation angle of the variable stator vane, in which the inner cylindrical member is provided as a seal ring that has a cylindrical shape about the rotor axis, and that has an outer peripheral surface and an end surface that is connected to an end of the outer peripheral surface in a rotor axis direction along which the rotor axis extends and that is perpendicular to the rotor axis, the outer peripheral surface being located on the radially inner side of the variable stator vane with respect to the rotor axis, and the seal ring supports the variable stator vane such that the variable stator vane is rotatable about the vane rotational axis, the vane angle measurement method comprising:
a disposition step of disposing the vane angle measurement device; and
an angle reading step of reading an angle indicated by the goniometer body after the disposition step,
wherein in the disposition step,
the device reference surface of the first leg is brought into contact with the first leg contact surface of the second member,
the arm height securing surface of the first leg is brought into contact with the second leg contact surface of the second member,
the second contact end of the second leg is brought into contact with the second leg contact surface of the second member, and thereafter the length from the substrate to the second contact end is changed as necessary to adjust an inclination of the substrate such that the measurement central axis is parallel to the vane rotational axis, and
the measurement arm is brought into contact with the arm contact surface of the first member,
the first member is provided as the variable stator vane,
the arm contact surface of the first member is provided as a pressure surface of the variable stator vane,
the second member is provided as the seal ring,
the first leg contact surface of the second member is provided as the end surface of the seal ring, and
the second leg contact surface of the second member is provided as the outer peripheral surface of the seal ring.

9. A vane angle measurement method for measuring, by using the vane angle measurement device according to claim 1, a rotation angle of the variable stator vane, in which the angle changing mechanism includes
an outer rotary shaft that is attached to an end of the variable stator vane on the radially outer side with respect to the rotor axis, and that has a cylindrical shape about the vane rotational axis,
a first link piece that is fixed to the outer rotary shaft and that extends in the radial direction with respect to the vane rotational axis, and
a rotating ring that is disposed on the radially outer side of the casing with respect to the rotor axis, that has an annular shape about the rotor axis, and that is rotatable about the rotor axis,
the first link piece has a link side surface that extends in the radial direction with respect to the vane rotational axis and in a vane rotational axis direction along which the vane rotational axis extends, and a link outer surface that extends in a direction intersecting the link side surface and that faces the radially outer side with respect to the rotor axis, and
the rotating ring has a ring end surface perpendicular to the rotor axis, the vane angle measurement method comprising:
a disposition step of disposing the vane angle measurement device; and
an angle reading step of reading an angle indicated by the goniometer body after the disposition step,
wherein in the disposition step,
the device reference surface of the first leg is brought into contact with the first leg contact surface of the second member,
the arm height securing surface of the first leg is brought into contact with the second leg contact surface of the second member,
the second contact end of the second leg is brought into contact with the second leg contact surface of the second member, and thereafter the length from the substrate to the second contact end is changed as necessary to adjust an inclination of the substrate such that the measurement central axis is parallel to the vane rotational axis, and
the measurement arm is brought into contact with the arm contact surface of the first member,
the first member is provided as the rotating ring,
the arm contact surface of the first member is provided as the ring end surface of the rotating ring,
the second member is provided as the first link piece,
the first leg contact surface of the second member is provided as the link side surface of the first link piece, and
the second leg contact surface of the second member is provided as the link outer surface of the first link piece.
